(19) United States
(12) Patent Application Publication
(10) Pub. No.: US 2025/0313236 A1
(43) Pub. Date: Oct. 9, 2025

(54) INFORMATION PROCESSING APPARATUS, INFORMATION PROCESSING METHOD, AND PROGRAM

(71) Applicant: SONY GROUP CORPORATION, TOKYO (JP)

(72) Inventors: TATSUYA ISHIKAWA, TOKYO (JP); NAOYUKI SATO, TOKYO (JP)

(21) Appl. No.: 18/698,196

(22) PCT Filed: Sep. 29, 2022
(86) PCT No.: PCT/JP2022/036366

§ 371 Date: Jun. 23, 2025

(30) Foreign Application Priority Data
Oct. 13, 2021 (JP) 2021-167856

(51) Int. Cl. B60W 60/00; B60W 50/06

(52) U.S. Cl. CPC B60W 60/0016; B60W 50/06; B60W 2556/00

(57) ABSTRACT

The present disclosure relates to an information processing apparatus, an information processing method, and a program which enable appropriate switching of a processing algorithm required in automated driving in accordance with a traveling environment.

An obstacle is recognized on the basis of sensor information by a recognition algorithm for recognizing the obstacle, a travel route of a mobile apparatus is planned by an action planning algorithm for planning the travel route, and control is performed to switch at least any of the recognition algorithm and the action planning algorithm on the basis of a traveling environment of the mobile apparatus. The present disclosure can be applied to a moving body apparatus that performs automated driving.

### TECHNICAL FIELD

The present disclosure relates to an information processing apparatus, an information processing method, and a program, and more particularly, to an information processing apparatus, an information processing method, and a program which enable appropriate switching of a processing algorithm required in automated driving in accordance with a traveling environment.

### BACKGROUND ART

There is proposed a technology for changing a parameter for controlling driving in accordance with a traveling environment in automated driving (see Patent Literature 1).

### CITATION LIST

### Patent Document

Patent Document 1: WO 2016/158197 A

### SUMMARY OF THE INVENTION

### Problems to be Solved by the Invention

However, in the technology described in Patent Literature 1, the parameter is changed in accordance with the traveling environment, a processing algorithm or the like related to the automated driving is constant, so that there is a possibility that processing is not necessarily suitable for the traveling environment.

The present disclosure has been made in view of such a situation, and particularly makes it possible to appropriately switch and change a processing algorithm required in automated driving in accordance with a traveling environment.

### Solutions to Problems

An information processing apparatus and a program according to one aspect of the present disclosure are an information processing apparatus and a program, the information processing apparatus including: a recognition unit that has a recognition algorithm for recognizing an obstacle and recognizes the obstacle by the recognition algorithm on the basis of sensor information; an action planning unit that has an action planning algorithm for planning a travel route, and plans the travel route of a mobile apparatus by the action planning algorithm; and a recognition action control unit that performs control to switch at least any of the recognition algorithm and the action planning algorithm on the basis of a traveling environment of the mobile apparatus.

An information processing method according to one aspect of the present disclosure is an information processing method including steps of: recognizing an obstacle on the basis of sensor information by a recognition algorithm for recognizing the obstacle; planning a travel route of a mobile apparatus by an action planning algorithm for planning the travel route; and performing control to switch at least any of the recognition algorithm and the action planning algorithm on the basis of a traveling environment of the mobile apparatus.

In one aspect of the present disclosure, the obstacle is recognized on the basis of the sensor information by the recognition algorithm for recognizing the obstacle, the travel route of the mobile apparatus is planned by the action planning algorithm for planning the travel route, and the control is performed to switch at least any of the recognition algorithm and the action planning algorithm on the basis of the traveling environment of the mobile apparatus.

### BRIEF DESCRIPTION OF DRAWINGS

FIG. 1 is a view for describing the presence or absence of an object to be subjected to object recognition in accordance with a road type as a traveling environment.

FIG. 2 is a view for describing an obstacle characteristic and a traveling characteristic in accordance with a road type in law.

FIG. 3 is a view for describing an obstacle characteristic and a traveling characteristic in accordance with a type of a private road.

FIG. 4 is a view for describing an obstacle characteristic in accordance with date and time or a season.

FIG. 5 is a block diagram illustrating a configuration example of an automated driving control system.

FIG. 6 is a block diagram illustrating a configuration example of a vehicle control system that controls a vehicle in FIG. 5.

FIG. 7 is a diagram illustrating an example of a sensing area.

FIG. 8 is a diagram for describing a configuration example of a recognition action management server in FIG. 5.

FIG. 9 is a flowchart for describing algorithm optimization processing by the vehicle.

FIG. 10 is a flowchart for describing stop algorithm switching processing in FIG. 9.

FIG. 11 is a flowchart for describing stop algorithm switching processing by the recognition action management server.

FIG. 12 is a diagram for describing a switching zone for switching an algorithm, the switching zone being set immediately before a road type is switched.

FIG. 13 is a diagram for describing a switching zone for switching an algorithm, the switching zone being set immediately before a road type is switched to a highway.

FIG. 14 is a diagram for describing a switching zone for switching an algorithm, the switching zone being set immediately before a road type is switched from a residential area to private land.

FIG. 15 is a flowchart for describing an application example of the algorithm optimization processing.

FIG. 16 is a flowchart for describing travel algorithm switching processing in FIG. 15.

FIG. 17 is a block diagram illustrating a configuration example of a general-purpose computer.

### MODE FOR CARRYING OUT THE INVENTION

Hereinafter, preferred embodiments of the present disclosure will be described in detail with reference to the accompanying drawings.

Note that, in the present specification and drawings, components having substantially the same functional configuration are denoted by the same reference signs, and redundant description is omitted.

Hereinafter, modes for carrying out the present technology will be described. The description will be given in the following order.
1. Overview of Present Disclosure
2. Obstacle Characteristic and Traveling Characteristic in Accordance with Road Type in Law
3. Obstacle Characteristic and Traveling Characteristic in Accordance with Type of Private Road
4. Obstacle characteristic in Accordance with Date and Time or Season
5. Configuration Example of Automated Driving Control System for Achieving Present Disclosure
6. Configuration Example of Vehicle Control System
7. Configuration Example of Recognition Action Management Server
8. Application Example
9. Example of Execution by Software

### 1. Overview of Present Disclosure

The present disclosure makes it possible to appropriately switch and change a processing algorithm required in automated driving in accordance with a traveling environment.

In general, in automated driving, an environment around a vehicle is sensed by sensors mounted on the vehicle, and object recognition processing of recognizing a position and a type of an object that is an obstacle is performed on the basis of a sensing result.

Then, action planning processing of planning a travel route is performed on the basis of a recognition result of a position and a type of an object that is an obstacle recognized by the object recognition processing, and an operation is controlled such that the vehicle moves along the travel route planned by the action planning processing.

The above-described technology described in Patent Literature 1 optimizes automated driving by changing a parameter for controlling an operation of a vehicle in accordance with a traveling environment, but an algorithm in the above-described object recognition processing and travel planning processing is not changed.

Therefore, the control of the automated driving cannot be optimized in accordance with the traveling environment, and there is a possibility that safety, travel quality, and various processing efficiencies required in the automatic traveling are reduced.

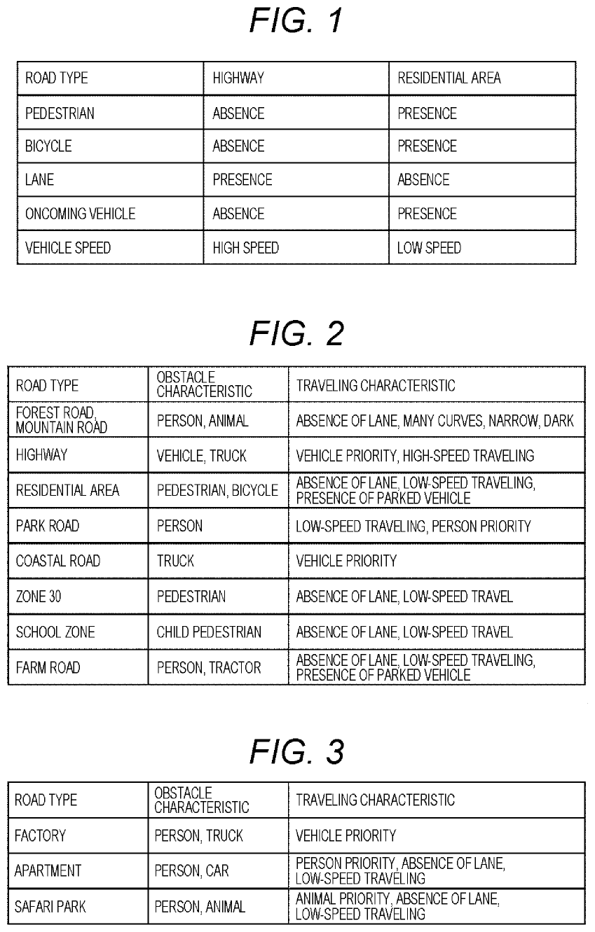

For example, as illustrated in FIG. 1, a type of an object to be recognized, a vehicle speed, and the like, which are necessary for controlling the automated driving, differ depending on a road type as the traveling environment.

FIG. 1 illustrates a comparison between the presence or absence of a pedestrian, a bicycle, a lane, and an oncoming vehicle as objects that need to be recognized as obstacles and a vehicle speed according to a traveling environment in each case where the traveling environment is a highway or a residential area.

Note that the presence or absence of an object to be recognized here indicates the frequency of the presence of the object, and an object considered to be “present” indicates that an existence probability (existence frequency) is higher than a predetermined value, and an object considered to be “absent” indicates that an existence probability (existence frequency) is lower than the predetermined value.

FIG. 1 illustrates that, on the highway, the pedestrian is absent, the bicycle is absent, the lane is present, the oncoming vehicle is absent, and the vehicle speed is high.

Furthermore, it is illustrated that, in the residential area, the pedestrian is present, the bicycle is present, the lane is absent, the oncoming vehicle is present, and the vehicle speed is low.

That is, when being compared as the traveling environment, the highway and the residential area have an inverse relationship regarding the presence or absence of the pedestrian, the bicycle, the lane, and the oncoming vehicle to be recognized. Furthermore, since the vehicle speed is high on the highway and is low in the residential area, there is an inverse relationship.

Therefore, on the highway, it can be considered that, a highly accurate recognition result is required for the lane having a high existence probability but a recognition result with somewhat low accuracy is allowed for the recognition accuracy of the pedestrian, the bicycle, and the oncoming vehicle that can be considered to have a low existence probability, for example, when the object recognition processing is considered.

On the other hand, in the residential area, a recognition result with somewhat low accuracy is allowed for the lane having a low existence probability, but a highly accurate recognition result is required for the pedestrian, the bicycle, and the oncoming vehicle whose existence probability is high, for example, when the object recognition processing is considered.

Furthermore, in the action planning processing of planning a travel route from an object recognition result, it is necessary to plan a travel route using a highly accurate recognition result for the lane having the high existence probability on the highway.

Moreover, in a case where the traveling environment is the highway, since the vehicle speed is high, the travel quality is degraded (ride comfort is deteriorated), for example, in order to make a travel route to be planned the shortest route for movement since a large acceleration is generated in the horizontal direction for an occupant due to a sudden right or left turn, turning, or the like if a travel route that changes rapidly is planned. Therefore, when a travel route is planned on the highway, it is necessary to plan a straight travel route even if the route is somewhat a detour such that a large degradation in the travel quality, such as the large acceleration in the horizontal direction, can be suppressed.

On the other hand, in the action planning processing, in the residential area, it can be considered that it is necessary to plan a travel route using a highly accurate recognition result for the oncoming vehicle having the high existence probability, but a travel route may be planned with a recognition result with somewhat low accuracy for the lane having the low existence probability.

Furthermore, since the vehicle speed is low, a large acceleration is not generated in the horizontal direction due to a right or left turn, turning, or the like even if a travel route that changes rapidly is planned, so that it is not necessary to consider the degradation in the travel quality. Therefore, in the action planning processing for the residential area, it is necessary to plan a more efficient travel route or a travel route with higher safety so as to be the shortest route even if a travel route having a somewhat large change in the right or left turn or rotation is planned.

In this manner, regarding the object recognition processing and the action planning processing required in the automated driving, a type of a recognition result required to be highly accurate and a target to be prioritized in planning a travel route differ depending on the traveling environment.

Therefore, for the object recognition processing and the action planning processing required in the automated driving, it is necessary to change related algorithms in accordance with the traveling environment.

Therefore, in the present disclosure, the algorithms related to the object recognition processing and the action planning processing are changed in accordance with the traveling environment.

Therefore, the algorithms related to the object recognition processing and the action planning processing are optimized in accordance with the traveling environment, so that the safety, travel quality, and efficiency related to the automated driving can be improved.

### 2. Obstacle Characteristic and Traveling Characteristic in Accordance with Road Type in Law

Since the algorithms related to the object recognition processing and the action planning processing are changed in accordance with a traveling environment in the present disclosure, first, an obstacle characteristic and a traveling characteristic corresponding to a road type in law as an example of the traveling environment will be described with reference to FIG. 2.

For example, as illustrated in FIG. 2, “forest road, mountain road”, “highway”, “residential area”, “park road”, “coastal road”, “zone 30 (road in a residential region where traveling at 30 km/h or less is stipulated)”, “school zone”, and “farm road” are considered as road types.

In this case, obstacle characteristics having a high existence probability according to road types are, for example, “person, animal” in “forest road, mountain road”, “vehicle, truck” in “highway”, and “pedestrian, bicycle” in “residential area”.

Furthermore, obstacle characteristics having a high existence probability are “person” in “park road”, “truck” in “coastal road”, “pedestrian” in “zone 30”, “child pedestrian” in “school zone”, and “person, tractor” in “farm road”.

On the other hand, as traveling characteristics that need to be considered in the action planning processing according to road types, for example, there are characteristics such as “absence of lane, many curves, narrow, dark” in “forest road, mountain road”, there are characteristics such as “vehicle priority, high-speed traveling” in “highway”, and there are characteristics such as “absence of lane, low-speed traveling, presence of parked vehicle” in “residential area”.

Furthermore, there are characteristics such as “low-speed traveling, person priority” in “park road”, “vehicle priority” in “coastal road”, “absence of lane, low-speed travel” in “zone 30” and “school zone”, and “absence of lane, low-speed traveling, and presence of parked vehicle” in “farm road”.

### 3. Obstacle Characteristic and Traveling Characteristic in Accordance with Type of Private Road

Next, an obstacle characteristic and a traveling characteristic in accordance with a type of a private road will be described with reference to FIG. 3.

For example, as illustrated in FIG. 3, “factory”, “apartment”, and “safari park” are considered as types of private roads.

In this case, obstacle characteristics having a high existence probability according to road types are, for example, “person, car” in “factory”, “person, car” in “apartment”, and “person, animal” in “safari park”.

On the other hand, as traveling characteristics that need to be considered in the action planning processing according to road types, for example, there is a characteristic such as “vehicle priority” in “factory”, there are characteristics such as “person priority, absence of lane, and low-speed traveling” in “apartment”, and there are characteristics such as “animal priority, absence of lane, and low-speed traveling” in “safari park”.

### 4. Obstacle Characteristic in Accordance with Date and Time or Season

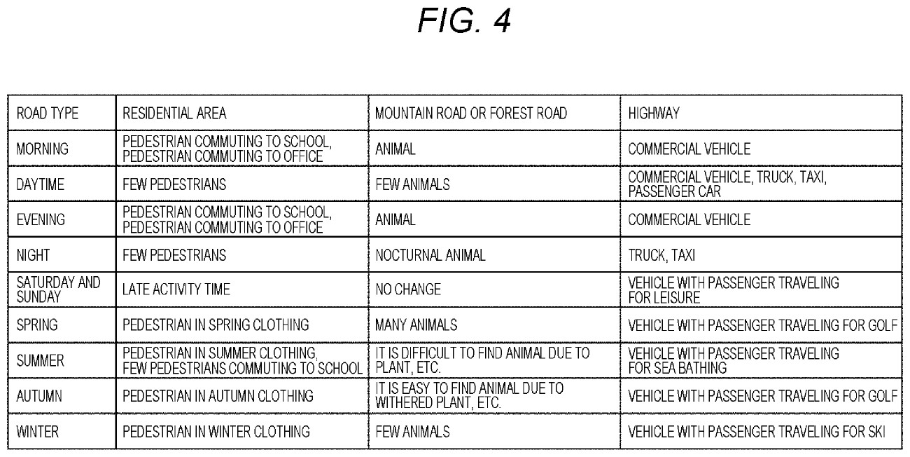

Next, an obstacle characteristic in accordance with date and time or a season will be described with reference to FIG. 4.

For example, as illustrated in FIG. 4, regarding each of the road types of “residential area”, “mountain road or forest road”, and “highway”, obstacle characteristics in “morning”, “daytime”, “evening”, “night”, and “Saturday and Sunday” as the date and time, and obstacle characteristics in “spring”, “summer”, “autumn”, and “winter” as seasons are considered.

In this case, in a case where the date and time is “morning”, obstacle characteristics according to road types are “pedestrian commuting to school, pedestrian commuting to office” in “residential area”, “animal” in “mountain road or forest road”, and “commercial vehicle” in “highway”.

In a case where the date and time is “daytime”, obstacle characteristics according to road types are “few pedestrians” in “residential area”, “few animals” in “mountain road or forest road”, and “commercial vehicle, truck, taxi, passenger car” in “highway”.

In a case where the date and time is “evening”, obstacle characteristics according to road types are “pedestrian commuting to school, pedestrian commuting to office” in “residential area”, “animal” in “mountain road or forest road”, and “commercial vehicle” in “highway”.

In a case where the date and time is “night”, obstacle characteristics according to road types are “few pedestrians” in “residential area”, “nocturnal animal” in “mountain road or forest road”, and “truck, taxi” in “highway”.

In a case where the date and time is “Saturday and Sunday”, obstacle characteristics according to road types are “late activity time” in “residential area”, “no change (as compared with weekdays)” in “mountain road or forest road”, and “vehicle with passenger traveling for leisure” in “highway”.

In a case where the season is “spring”, obstacle characteristics according to road types are “pedestrian in spring clothing” in “residential area”, “many animals” in “mountain road or forest road” since animals act actively according to the breeding period, and “vehicle with passenger traveling for golf” in “highway”.

In a case where the season is “summer”, obstacle characteristics according to road types are “pedestrian in summer clothing” in “residential area”, “it is difficult to find animal due to plant and the like” in “mountain road or forest road”, and “vehicle with passenger traveling for sea bathing” in “highway”.

In a case where the season is “autumn”, obstacle characteristics according to road types are “pedestrian in autumn clothing” in “residential area”, “it is easy to find animal due to withered plant and the like” in “mountain road or forest road”, and “vehicle with passenger traveling for golf” in “highway”.

In a case where the season is “winter”, obstacle characteristics according to road types are “pedestrian in winter clothing” in “residential area”, “few animals” in “mountain road or forest road” since animals become less active, and “vehicle with passenger traveling for ski” in “highway”.

Note that the obstacle characteristics according to the date and time and the season have been described in FIG. 4, but there are similar changes in the corresponding traveling characteristics or the like.

For example, since the sunrise time changes depending on “morning”, “daytime”, “evening”, “night”, “Saturday and Sunday”, “spring”, “summer”, “autumn”, “winter”, and the like, for example, the visibility of a vehicle by a pedestrian changes depending on time. Thus, it is necessary to change a distance to a pedestrian when passing by the pedestrian in planning a travel route or plan the travel route in consideration of freezing of a road surface due to a change in air temperature according to the season.

In this manner, the obstacle characteristics and the traveling characteristics change in accordance with the road type, the date and time, the season, and the like which are traveling environments.

Furthermore, what changes the obstacle characteristics and the traveling characteristics includes not only the road type, the date and time, and the season, but also other factors. For example, the traveling environment changes depending on the weather, the presence or absence of a large-scale event (a festival, a sports tournament, an exhibition, or the like), the presence or absence of a trouble in public transportation (suspension, delay, or the like), and the like.

That is, since an obstacle to be recognized with higher accuracy differs depending on the traveling environment including the road type, the date and time, the season, the other factors described above, and the like, in the object recognition processing, it is considered desirable that an obstacle that needs to be recognized with higher accuracy is changed by switching to an algorithm capable of recognizing with higher accuracy in accordance with the traveling environment.

Furthermore, since the traveling characteristic differs depending on the traveling environment including the road type, the date and time, the season, the other factors described above, and the like, it is considered desirable that an algorithm is switched and changed such that a travel route which may improve safety, travel quality, and various efficiencies is planned in accordance with the traveling environment in the action planning processing of planning the travel route.

Therefore, in the present disclosure, algorithms in the object recognition processing and the travel planning processing are changed in accordance with the traveling environment described above.

### <Algorithm of Object Recognition Processing>

Regarding the algorithm of the object recognition processing, for example, in accordance with the traveling environment, an algorithm in which the object recognition processing is performed at a higher frequency for an obstacle having a high existence probability may be used or switching to an algorithm obtained by reinforcement learning using an obstacle that needs to be detected with higher accuracy may be performed.

Conversely, for an obstacle having a low existence probability, the frequency of the object recognition processing is reduced, the object recognition processing is stopped as necessary, or the object recognition processing itself is stopped by excluding the obstacle from recognition targets.

More specifically, for example, in a case where the traveling environment is a highway, a frequency of walking of a person is extremely low. Thus, on the highway, the algorithm is changed to turn off the object recognition processing for the person or to lower the frequency of the object recognition processing for the person, thereby improving the efficiency of the object recognition processing.

Furthermore, for example, in a case where the traveling environment is a residential area including a narrow road, a frequency of traveling of a truck is low. Thus, the algorithm is changed to turn off the object recognition processing for the truck or to lower the frequency of the object recognition processing for the truck, thereby speeding up the object recognition processing.

In addition, the algorithm of the object recognition processing is switched to turn on or off the object recognition processing for an obstacle having a high or low existence probability and to perform switching of the frequency in accordance with the traveling environment as illustrated in FIGS. 2 to 4.

### <Algorithm of Action Planning Processing>

As the algorithm of the action planning processing, there are generally known algorithms such as a dynamic window approach (DWA) method, a reinforcement learning method, and a local trajectory planner (TLP) method.

The dynamic window approach (DWA) method is one of methods of algorithms of the action planning processing of sequentially searching for directions suitable for traveling and planning a travel route to a destination.

Since the DWA method is a simple algorithm, a calculation amount is small, and it is possible to reduce a load related to the action planning processing.

However, it is known that the DWA method is difficult to customize medium and long-term motions such as obstacle avoidance, has poor followability to a designated path, and is likely to cause a travel route planned in a low-speed range to meander.

The reinforcement learning method is one of methods of algorithms of the action planning processing of planning a travel route on the basis of, for example, an object that is an obstacle recognized by the object recognition processing or a position of the object using a deep neural network formed by deep learning.

In the reinforcement learning method, a smooth motion can be implemented by planning a travel route using the deep neural network formed by deep learning, and obstacle avoidance for an unknown state can be implemented.

However, it is known that the algorithm of the reinforcement learning method requires time to form the deep neural network with predetermined accuracy or more by deep learning, and thus, is difficult to logically analyze a motion of a moving body in implementing traveling along the planned travel route. Furthermore, it is known that stop accuracy at the time of stopping not to interfere with an obstacle is low in the travel route planned by the algorithm of the reinforcement learning method has low.

The local trajectory planner (LTP) method is one of methods of algorithms that implement the action planning processing of planning a travel route by sequentially repeating a process of planning a trajectory to a sub-goal several meters ahead, and plans a speed plan that is a change in a moving speed together with the travel route.

In the LTP method, a motion is easily customized, the followability to a designated path is high, and the stop accuracy is good since the speed plan is made as well as the linearity is high.

However, in the LTP method, a processing load related to the travel planning processing is great because a calculation amount is large.

Therefore, as described above, the optimization of the travel route planned by the travel planning processing and the control of processing load are performed by switching the algorithm of the travel planning processing in accordance with the traveling environment.

More specifically, for example, in a case where the traveling environment is an environment in which the load related to the action planning processing is likely to increase, such as a case where there are many obstacles to be considered at the time of planning a travel route or there are many routes as options, the algorithm may be switched to the DWA method in order to reduce the load related to the action planning processing.

Furthermore, when the traveling environment is, for example, a place with many people such as a shopping street, or when it is desired to improve the travel quality (ride comfort) by reducing a sudden change in the course, the algorithm of the action planning processing may be switched to the reinforcement learning method in order to plan a travel route that allows seamless (smooth) travel.

Moreover, in a case where it is necessary to avoid an obstacle with higher accuracy and there may be a somewhat sudden course change or the like in the traveling environment, the algorithm of the action planning processing may be switched to the LTP method.

More specifically, the algorithm of the action planning processing may be switched and changed to the LTP method in a case where it is desired to prioritize the safety over the travel quality by making it possible to plan a travel route with high safety by taking a sufficient distance at the time of avoiding a person in or around a site of an apartment or the like, for example, in the traveling environment.

Furthermore, not only the method of the algorithm related to the travel planning processing is switched, but also a parameter may be changed in accordance with the traveling environment in a predetermined algorithm.

More specifically, for example, in the case of the action planning processing using the algorithm of the DWA method or the LTP method, during travel on a left lane when the traveling environment is a road with two lanes, a travel route only when the lane is changed to a right lane may be planned and evaluated at the time of planning the travel route

Furthermore, in the case of the algorithm of the LTP method, an avoidance distance from an obstacle may be set to be long when the traveling environment is a residential area or the like, and conversely, the avoidance distance may be set to be narrow when the traveling environment is a factory or the like.

Moreover, in the case of the algorithm of the LTP method, when the traveling environment is the residential area or the like, many sub-goals may be set to increase the number of avoidance routes in order to emphasize the safety.

Furthermore, the algorithm of the object recognition processing and the algorithm of the travel planning processing may be simultaneously switched in accordance with the traveling environment, or either one may be switched.

### 5. Configuration Example of Automated Driving Control System for Achieving Present Disclosure

Next, a configuration example of an automated driving control system that implements automated driving control of a vehicle by simultaneously switching the above-described object recognition processing algorithm and travel planning processing algorithm in accordance with a traveling environment will be described.

Note that an example in which the object recognition processing algorithm and the travel planning processing algorithm are simultaneously switched in accordance with the traveling environment will be described here, but it goes without saying that any one of the object recognition processing algorithm and the travel planning processing algorithm may be switched in accordance with the traveling environment.

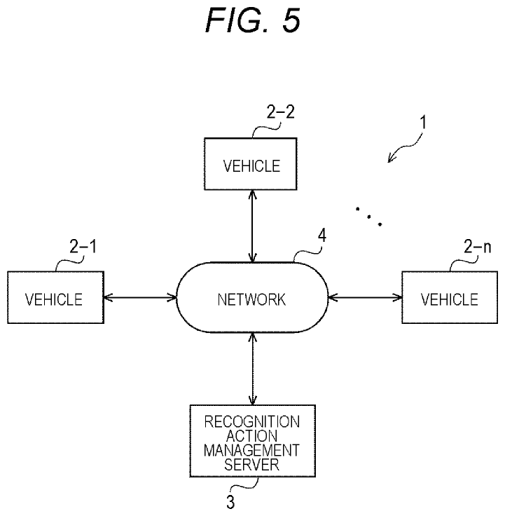

An automated driving control system 1 in FIG. 5 includes vehicles 2-1 to 2-n, a recognition action management server 3, and a network 4, and the vehicles 2-1 to 2-n and the recognition action management server 3 are configured to be able to communicate with each other via the network 4 including a public line or the like.

Note that, hereinafter, each of the vehicles 2-1 to 2-n is simply referred to as a vehicle 2 in a case where it is not necessary to particularly distinguish them, and other configurations are also referred to in a similar manner.

The vehicle 2 is a vehicle that implements automated driving, stores a high-precision map in which positions on a map and information regarding traveling environments are registered in advance, detects information regarding its current position on the earth, and then, collates the current position on the high-precision map when detecting to recognize a traveling environment at the current position.

The vehicle 2 switches the algorithm related to the object recognition processing and the algorithm (including parameters) related to the action planning processing described above on the basis of the recognized traveling environment, executes the object recognition processing, and executes the action planning processing on the basis of an object recognition result, thereby planning a travel route and autonomously traveling on the travel route. Note that, hereinafter, the algorithm related to the object recognition processing is also referred to as a recognition algorithm, and the algorithm related to the action planning processing is also referred to as an action planning algorithm.

Furthermore, the recognition algorithm and the action planning algorithm are also collectively and simply referred to as an algorithm.

The recognition action management server 3 stores, in advance, a recognition algorithm related to the object recognition processing and an action planning algorithm related to the action planning processing for each traveling environment, reads corresponding recognition algorithm and action planning algorithm in accordance with a traveling environment supplied from the vehicle 2, and supplies the read recognition algorithm and action planning algorithm to the vehicle 2.

The vehicle 2 may store a plurality of recognition algorithms related to body recognition processing and a plurality of action planning algorithms related to the action planning processing according to traveling environments and switch and change the algorithms in accordance with the traveling environment, or may present information regarding the traveling environment to the recognition action management server 3 to request and acquire corresponding recognition algorithm and action planning algorithm, and then, switch and change the algorithms.

Moreover, regarding the recognition algorithm and the action planning algorithm, the vehicle 2 may store, for example, an algorithm having a high use frequency according to the traveling environment and request the recognition action management server 3 for an algorithm having a low use frequency, acquire, and then, switch and change the algorithm.

### 6. Configuration Example of Vehicle Control System

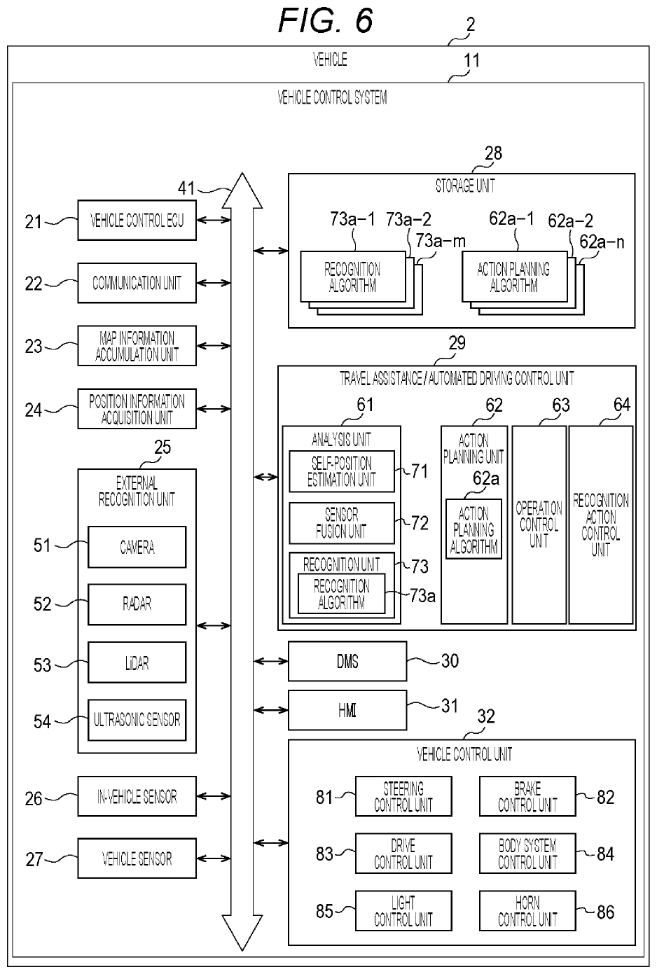

FIG. 6 is a block diagram illustrating a configuration example of a vehicle control system 11 that is an example of a mobile apparatus control system to which the present technology is applied.

The vehicle control system 11 is provided in a vehicle 2 and performs processing related to travel assistance and automated driving of the vehicle 2.

The vehicle control system 11 includes a vehicle control electronic control unit (ECU) 21, a communication unit 22, a map information accumulation unit 23, a position information acquisition unit 24, an external recognition sensor 25, an in-vehicle sensor 26, a vehicle sensor 27, a storage unit 28, a travel assistance/automated driving control unit 29, a driver monitoring system (DMS) 30, a human machine interface (HMI) 31, and a vehicle control unit 32.

The vehicle control ECU 21, the communication unit 22, the map information accumulation unit 23, the position information acquisition unit 24, the external recognition sensor 25, the in-vehicle sensor 26, the vehicle sensor 27, the storage unit 28, the travel assistance/automated driving control unit 29, the driver monitoring system (DMS) 30, the human machine interface (HMI) 31, and the vehicle control unit 32 are communicably connected to each other via a communication network 41. The communication network 41 includes, for example, an in-vehicle communication network, a bus, or the like that conforms to a digital bidirectional communication standard such as a controller area network (CAN), a local interconnect network (LIN), a local area network (LAN), FlexRay (registered trademark), or Ethernet (registered trademark). The communication network 41 may be selectively used depending on the type of data to be transmitted. For example, the CAN may be applied to data related to vehicle control, and the Ethernet may be applied to large-volume data. Note that there is also a case where the respective units of the vehicle control system 11 are directly connected to each other using wireless communication on an assumption of communication at a relatively near distance, such as near field communication (NFC) and Bluetooth (registered trademark) without using the communication network 41, for example.

Note that, hereinafter, in a case where each unit of the vehicle control system 11 performs communication via the communication network 41, the description of the communication network 41 will be omitted. For example, in a case where the vehicle control ECU 21 and the communication unit 22 perform communication via the communication network 41, it will be simply described that the vehicle control ECU 21 and the communication unit 22 perform communication.

For example, the vehicle control ECU 21 includes various processors such as a central processing unit (CPU) and a micro processing unit (MPU). The vehicle control ECU 21 controls all or some of the functions of the vehicle control system 11.

The communication unit 22 communicates with various devices inside and outside the vehicle, another vehicle, a server, a base station, and the like, and transmits and receives various types of data. At that time, the communication unit 22 can perform communication using a plurality of communication methods.

Communication with the outside of the vehicle executable by the communication unit 22 will be schematically described. The communication unit 22 communicates with a server (hereinafter, referred to as an external server) or the like present on an external network via a base station or an access point by, for example, a wireless communication method such as fifth generation mobile communication system (5G), long term evolution (LTE), dedicated short range communications (DSRC), or the like. Examples of the external network with which the communication unit 22 performs communication include the Internet, a cloud network, a company-specific network, and the like. The communication method by which the communication unit 22 communicates with the external network is not particularly limited as long as it is a wireless communication method allowing digital bidirectional communication at a communication speed equal to or higher than a predetermined speed and over a distance equal to or longer than a predetermined distance.

Furthermore, for example, the communication unit 22 can communicate with a terminal present in the vicinity of a host vehicle using a peer to peer (P2P) technology. The terminal present in the vicinity of the host vehicle is, for example, a terminal attached to a moving body moving at a relatively low speed such as a pedestrian or a bicycle, a terminal fixedly installed in a store or the like, or a machine type communication (MTC) terminal. Moreover, the communication unit 22 can also perform V2X communication. The V2X communication refers to, for example, communication between the host vehicle and another vehicle, such as vehicle to vehicle communication with another vehicle, vehicle to infrastructure communication with a roadside device or the like, vehicle to home communication, and vehicle to pedestrian communication with a terminal or the like carried by a pedestrian.

For example, the communication unit 22 can receive a program for updating software for controlling the operation of the vehicle control system 11 from the outside (Over The Air). The communication unit 22 can further receive map information, traffic information, the information regarding the surroundings of the vehicle 2, and the like from the outside. Furthermore, for example, the communication unit 22 can transmit information regarding the vehicle 2, information regarding the surroundings of the vehicle 2, and the like to the outside. Examples of the information regarding the vehicle 2 transmitted to the outside by the communication unit 22 include data indicating a state of the vehicle 2, a recognition result from a recognition unit 73, or the like. Moreover, for example, the communication unit 22 performs communication corresponding to a vehicle emergency call system such as an eCall.

For example, the communication unit 22 receives an electromagnetic wave transmitted by a road traffic information communication system (vehicle information and communication system (VICS) (registered trademark)), such as a radio wave beacon, an optical beacon, or FM multiplex broadcasting.

Communication with the inside of the vehicle executable by the communication unit 22 will be schematically described. The communication unit 22 can communicate with each device in the vehicle using, for example, wireless communication. The communication unit 22 can perform wireless communication with a device in the vehicle by, for example, a communication method allowing digital bidirectional communication at a communication speed equal to or higher than a predetermined speed by wireless communication, such as wireless LAN, Bluetooth, NFC, or wireless USB (WUSB). Besides this, the communication unit 22 can also communicate with each device in the vehicle, using wired communication. For example, the communication unit 22 can communicate with each device in the vehicle by wired communication via a cable connected to a connection terminal (not illustrated). The communication unit 22 can communicate with each device in the vehicle by a communication method allowing digital bidirectional communication at a communication speed equal to or higher than a predetermined speed by wired communication, such as universal serial bus (USB), high-definition multimedia interface (HDMI) (registered trademark), or mobile high-definition link (MHL).

Here, the device in the vehicle refers to, for example, a device that is not connected to the communication network 41 in the vehicle. As the device in the vehicle, for example, a mobile device or a wearable device carried by an occupant such as a driver, an information device brought into the vehicle and temporarily installed, or the like is assumed.

The map information accumulation unit 23 accumulates one or both of a map acquired from the outside and a map created by the vehicle 2. For example, the map information accumulation unit 23 accumulates a three-dimensional high-precision map, a global map having a lower precision than the precision of the high-precision map but covering a wider area, and the like.

The high-precision map is, for example, a dynamic map, a point cloud map, a vector map, or the like. The dynamic map is, for example, a map including four layers of dynamic information, semi-dynamic information, semi-static information, and static information, and is provided to the vehicle 2 from the external server or the like. The point cloud map is a map including a point cloud (point cloud data). The vector map is, for example, a map in which traffic information such as a lane and a position of a traffic light is associated with a point cloud map and adapted to an advanced driver assistance system (ADAS) or autonomous driving (AD). In the high-precision map, information for specifying the above-described traveling environment is further registered for each predetermined range of a position on the map.

The point cloud map and the vector map may be provided from, for example, the external server or the like, or may be created by the vehicle 2 and accumulated in the map information accumulation unit 23 as a map for performing matching with a local map to be described later on the basis of a sensing result from a camera 51, a radar 52, a light detection and ranging or laser imaging detection and ranging (LiDAR) 53, or the like. Furthermore, in a case where the high-precision map is provided from the external server or the like, for example, map data of several hundred meters square regarding a planned route on which the vehicle 2 is to travel from now is acquired from the external server or the like in order to reduce the communication volume.

The position information acquisition unit 24 receives a global navigation satellite system (GNSS) signal from a GNSS satellite and acquires position information of the vehicle 2. The acquired position information is supplied to the travel assistance/automated driving control unit 29. Note that the position information acquisition unit 24 is not limited to a scheme using the GNSS signal and may acquire the position information, for example, using a beacon.

The external recognition sensor 25 includes various sensors used to recognize a situation outside the vehicle 2 and supplies sensor data from each sensor to each unit of the vehicle control system 11. The type and number of sensors included in the external recognition sensor 25 are arbitrary.

For example, the external recognition sensor 25 includes the camera 51, the radar 52, the light detection and ranging or laser imaging detection and ranging sensor (LiDAR) 53, and an ultrasonic sensor 54. Besides this, the external recognition sensor 25 may have a configuration including one or more types of sensors among the camera 51, the radar 52, the LiDAR 53, and the ultrasonic sensor 54. The number of cameras 51, the number of radars 52, the number of LiDARs 53, and the number of ultrasonic sensors 54 are not particularly limited as long as they can be practically installed in the vehicle 2. Furthermore, the types of the sensors included in the external recognition sensor 25 are not limited to these examples, and the external recognition sensor 25 may include other types of sensors. An example of a sensing area of each sensor included in the external recognition sensor 25 will be described later.

Note that an imaging method of the camera 51 is not particularly limited. For example, cameras of various imaging methods such as a time of flight (ToF) camera, a stereo camera, a monocular camera, and an infrared camera, which are imaging methods capable of distance measurement, can be applied to the camera 51 as necessary. Besides this, the camera 51 may simply acquire a captured image regardless of distance measurement.

Furthermore, for example, the external recognition sensor 25 can include an environment sensor for detecting an environment for the vehicle 2. The environment sensor is a sensor for detecting an environment such as weather, climate, or brightness, and can include various sensors such as a raindrop sensor, a fog sensor, a sunshine sensor, a snow sensor, and an illuminance sensor, for example.

Moreover, for example, the external recognition sensor 25 includes a microphone used for detection or the like of a sound around the vehicle 2 or a position of a sound source.

The in-vehicle sensor 26 includes various sensors for detecting information regarding the inside of the vehicle, and supplies sensor data from each sensor to each unit of the vehicle control system 11. The types and number of various sensors included in the in-vehicle sensor 26 are not particularly limited as long as the sensors have a type and number that practically allow installation in the vehicle 2.

For example, the in-vehicle sensor 26 can include one or more sensors of a camera, a radar, a seating sensor, a steering wheel sensor, a microphone, and a biometric sensor. As the camera included in the in-vehicle sensor 26, for example, cameras of various imaging methods capable of measuring a distance, such as a ToF camera, a stereo camera, a monocular camera, and an infrared camera, can be used.

Besides this, the camera included in the in-vehicle sensor 26 may simply acquire a captured image regardless of distance measurement. The biometric sensor included in the in-vehicle sensor 26 is provided, for example, on a seat, a steering wheel, or the like and detects various sorts of biological information of an occupant such as a driver.

The vehicle sensor 27 includes various sensors for detecting a state of the vehicle 2, and supplies sensor data from each sensor to each unit of the vehicle control system 11. The type and number of various sensors included in the vehicle sensor 27 are not particularly limited as long as they are types and numbers that can be practically installed in the vehicle 2.

For example, the vehicle sensor 27 includes a speed sensor, an acceleration sensor, an angular velocity sensor (gyro sensor), and an inertial measurement unit (IMU) obtained by integrating these sensors. For example, the vehicle sensor 27 includes a steering angle sensor that detects a steering angle of a steering wheel, a yaw rate sensor, an accelerator sensor that detects an operation amount of an accelerator pedal, and a brake sensor that detects an operation amount of a brake pedal. For example, the vehicle sensor 27 includes a rotation sensor that detects the number of rotations of an engine or a motor, an air pressure sensor that detects the air pressure of a tire, a slip rate sensor that detects the slip rate of the tire, and a wheel speed sensor that detects the rotation speed of a wheel. For example, the vehicle sensor 27 includes a battery sensor that detects the state of charge and temperature of a battery, and an impact sensor that detects an external impact.

The storage unit 28 includes at least one of a nonvolatile storage medium or a volatile storage medium, and stores data and a program. The storage unit 28 is used as, for example, an electrically erasable programmable read only memory (EEPROM) and a random access memory (RAM), and a magnetic storage device such as a hard disc drive (HDD), a semiconductor storage device, an optical storage device, and a magneto-optical storage device can be applied as a storage medium. The storage unit 28 stores various programs and data used by each unit of the vehicle control system 11. For example, the storage unit 28 includes an event data recorder (EDR) and a data storage system for automated driving (DSSAD), and stores information regarding the vehicle 2 before and after an event such as an accident and information acquired by the in-vehicle sensor 26. Moreover, the storage unit 28 stores action planning algorithms 62a-1 to 62a-n and recognition algorithms 73a-1 to 73a-m, which are algorithms corresponding to traveling environments in the recognition unit 73 and the action planning unit 62 corresponding to the above-described object recognition processing and travel planning processing, respectively.

The travel assistance/automated driving control unit 29 controls travel assistance and automated driving of the vehicle 2. For example, the travel assistance/automated driving control unit 29 includes an analysis unit 61, an action planning unit 62, an operation control unit 63, and a recognition action control unit 64.

The analysis unit 61 executes analysis processing for the vehicle 2 and its surrounding situation. The analysis unit 61 includes a self-position estimation unit 71, a sensor fusion unit 72, and a recognition unit 73.

The self-position estimation unit 71 estimates a self-position of the vehicle 2 on the basis of sensor data from the external recognition sensor 25 and the high-precision map accumulated in the map information accumulation unit 23. For example, the self-position estimation unit 71 generates a local map on the basis of sensor data from the external recognition sensor 25 and estimates the self-position of the vehicle 2 by matching the local map with the high-precision map. The position of the vehicle 2 is based on, for example, a center of a rear wheel pair axle.

The local map is, for example, a three-dimensional high-precision map created using a technology such as simultaneous localization and mapping (SLAM), an occupancy grid map, or the like. The three-dimensional high-precision map is, for example, the above-described point cloud map or the like. The occupancy grid map is a map in which a three-dimensional or two-dimensional space around the vehicle 2 is divided into grids (lattices) of a predetermined size, and an occupancy state of an object is indicated in units of grids. The occupancy state of the object is indicated by, for example, the presence or absence or existence probability of the object. The local map is also used for detection processing and recognition processing for a situation outside the vehicle 2 by the recognition unit 73, for example.

Note that the self-position estimation unit 71 may estimate the self-position of the vehicle 2 on the basis of the position information acquired by position information acquisition unit 24 and sensor data from the vehicle sensor 27.

The sensor fusion unit 72 performs sensor fusion processing of combining a plurality of different types of sensor data (for example, image data supplied from the camera 51 and sensor data supplied from the radar 52), to acquire new information. Methods for combining different types of sensor data include integration, fusion, association, or the like.

The recognition unit 73 executes detection processing of detecting the situation outside the vehicle 2 and recognition processing of recognizing the situation outside the vehicle 2.

For example, the recognition unit 73 performs the detection processing and the recognition processing for the situation outside the vehicle 2 on the basis of information from the external recognition sensor 25, information from the self-position estimation unit 71, information from the sensor fusion unit 72, and the like.

Specifically, for example, the recognition unit 73 performs the detection processing, the recognition processing, and the like for an object around the vehicle 2. The detection processing of the object is, for example, processing of detecting presence or absence, a size, a shape, a position, a motion, and the like of the object. The recognition processing of the object is, for example, processing of recognizing an attribute such as a type of the object or identifying a specific object. The detection processing and the recognition processing, however, are not always clearly separated and may overlap.

For example, the recognition unit 73 detects an object around the vehicle 2 by performing clustering to classify point clouds based on sensor data from the radar 52, the LiDAR 53, or the like into clusters of point clouds. Therefore, the presence or absence, size, shape, and position of the object around the vehicle 2 are detected.

For example, the recognition unit 73 detects a motion of an object around the vehicle 2 by performing tracking to follow a motion of the cluster of point clouds classified by clustering. Therefore, a speed and a traveling direction (movement vector) of the object around the vehicle 2 are detected.

For example, the recognition unit 73 detects or recognizes a vehicle, a person, a bicycle, an obstacle, a structure, a road, a traffic light, a traffic sign, a road sign, and the like on the basis of the image data supplied from the camera 51. Furthermore, the recognition unit 73 may recognize a type of an object around the vehicle 2 by performing recognition processing such as semantic segmentation.

For example, the recognition unit 73 can perform recognition processing for traffic rules around the vehicle 2 on the basis of a map accumulated in the map information accumulation unit 23, a result of estimation of the self-position by the self-position estimation unit 71, and a result of recognition of an object around the vehicle 2 by the recognition unit 73. Through this processing, the recognition unit 73 can recognize a position and a state of a traffic light, the content of a traffic sign and a road sign, the content of traffic regulations, a travelable lane, and the like.

For example, the recognition unit 73 can perform recognition processing for a surrounding environment of the vehicle 2. As the surrounding environment to be recognized by the recognition unit 73, weather, air temperature, humidity, brightness, road surface conditions, and the like are assumed.

Moreover, the recognition unit 73 is configured to implement the above-described object recognition processing, stores a recognition algorithm 73a corresponding to a traveling environment at a current position, and executes the stored recognition algorithm 73a to implement the object recognition processing. The recognition algorithm 73a stored in the recognition unit 73 is managed by the recognition action control unit 64, and is controlled to be switched to one corresponding to a traveling environment at a current position. Note that the recognition unit 73 may use a default recognition algorithm 73a that is generally used when the operation is started or when a current position is unknown so that a traveling environment cannot be recognized.

The action planning unit 62 creates an action plan for the vehicle 2. For example, the action planning unit 62 creates an action plan by executing processing of route planning and route following.

Note that the route planning (global path planning) is processing of planning a rough route from a start to a goal. This route planning also includes processing called trajectory planning (local path planning) to generate a trajectory in a planned route that allows the vehicle 2 to go safely and smoothly in the vicinity of the vehicle 2 in consideration of motion characteristics of the vehicle 2.

The route following is processing of planning an operation for safely and accurately traveling a route planned by the route planning within a planned time. For example, the action planning unit 62 can calculate a target speed and a target angular velocity of the vehicle 2, on the basis of a result of the processing of route following.

The action planning unit 62 is configured to implement the above-described action planning processing, stores a corresponding action planning algorithm 62a in accordance with a traveling environment at a current position, and executes the stored action planning algorithm 62a to implement the action planning processing. The action planning algorithm 62a stored in the action planning unit 62 is managed by the recognition action control unit 64 and is controlled to be switched to one corresponding to a traveling environment at a current position. Note that the action planning unit 62 may use a default action planning algorithm 62a that is generally used when the operation is started or when a current position is unknown so that a traveling environment cannot be recognized.

The operation control unit 63 controls the operation of the vehicle 2 in order to achieve the action plan created by the action planning unit 62.

For example, the operation control unit 63 controls a steering control unit 81, a brake control unit 82, and a drive control unit 83 included in the vehicle control unit 32 as described later and performs acceleration and deceleration control and direction control such that the vehicle 2 goes through the trajectory calculated by the trajectory planning. For example, the operation control unit 63 performs coordinated control for the purpose of implementing the functions of the ADAS such as collision avoidance or impact mitigation, follow-up traveling, vehicle-speed maintaining traveling, warning of collision of the host vehicle, warning of lane departure of the host vehicle, and the like. For example, the operation control unit 63 performs coordinated control for the purpose of automated driving or the like in which a vehicle autonomously travels without depending on the operation of the driver.

The recognition action control unit 64 reads information regarding a traveling environment at a corresponding position on the high-precision map accumulated in the map information accumulation unit 23, and specifies the traveling environment at a current position on the basis of position information supplied from the position information acquisition unit 24. Then, the recognition action control unit 64 searches the storage unit 28 for the recognition algorithm 73a and the action planning algorithm 62a which correspond to the specified traveling environment, and supplies the algorithms to the recognition unit 73 and the action planning unit 62 for switching and changing. Furthermore, when the recognition algorithm 73a and the action planning algorithm 62a which correspond to the traveling environment cannot be searched in the storage unit 28, the recognition action control unit 64 controls the communication unit 22 to request, via the network 4, the recognition action management server 3 for the corresponding recognition algorithm 73a and action planning algorithm 62a together with the information regarding the traveling environment at the current position, and acquires and supplies the algorithms to the recognition unit 73 and the action planning unit 62 for switching and changing.

The DMS 30 performs authentication processing for the driver, recognition processing for a state of the driver, and the like on the basis of sensor data from the in-vehicle sensor 26, input data input to the HMI 31 as described later, and the like. As the state of the driver to be recognized, for example, a physical condition, an alertness level, a concentration level, a fatigue level, a line-of-sight direction, a drunkenness level, a driving operation, a posture, and the like are assumed.

Note that the DMS 30 may perform authentication processing for an occupant other than the driver and recognition processing for a state of the occupant. Furthermore, for example, the DMS 30 may perform recognition processing for a situation inside the vehicle on the basis of sensor data from the in-vehicle sensor 26. As the situation inside the vehicle to be recognized, for example, air temperature, humidity, brightness, odor, and the like are assumed.

The HMI 31 receives inputs of various types of data, instructions, or the like, and presents various types of data to the driver or the like.

The input of data through the HMI 31 will be schematically described. The HMI 31 includes an input device for a person to input data. The HMI 31 generates an input signal on the basis of data, an instruction, or the like input with the input device, and supplies the input signal to each unit of the vehicle control system 11. The HMI 31 includes, for example, an operation element such as a touch panel, a button, a switch, and a lever as the input device. Besides this, the HMI 31 may further include an input device capable of inputting information by a method such as voice or gesture other than a manual operation. Moreover, the HMI 31 may use, for example, a remote control device using infrared rays or radio waves, or an external connection device such as a mobile device or a wearable device adapted to the operation of the vehicle control system 11 as an input device.

Presentation of data by the HMI 31 will be schematically described. The HMI 31 generates visual information, auditory information, and haptic information regarding an occupant or the outside of a vehicle. Furthermore, the HMI 31 performs output control for controlling the output, output content, output timing, output method, and the like of each piece of generated information. The HMI 31 generates and outputs, as the visual information, information indicated by images or light, such as an operation screen, a display of the state of the vehicle 2, a warning display, and a monitor image indicating a situation around the vehicle 2, for example. Furthermore, the HMI 31 generates and outputs, as the auditory information, information indicated by sounds such as voice guidance, a warning sound, and a warning message, for example. Moreover, the HMI 31 generates and outputs, as the haptic information, information given to the tactile sense of an occupant by, for example, force, vibration, motion, or the like.

As an output device from which the HMI 31 outputs the visual information, for example, a display apparatus that presents the visual information by displaying an image thereon or a projector apparatus that presents the visual information by projecting an image can be applied. Note that the display apparatus may be an apparatus that displays the visual information in the field of view of an occupant, such as a head-up display, a transmissive display, or a wearable device having an augmented reality (AR) function, as an example, as well as a display apparatus having an ordinary display. Furthermore, in the HMI 31, a display device included in a navigation device, an instrument panel, a camera monitoring system (CMS), an electronic mirror, a lamp, or the like provided in the vehicle 2 can also be used as the output device that outputs the visual information.

As the output device from which the HMI 31 outputs the auditory information, for example, an audio speaker, a headphone, or an earphone can be applied.

As an output device from which the HMI 31 outputs the haptic information, for example, a haptic element using a haptic technology can be applied. The haptic element is provided, for example, in a portion to be touched by the occupant of the vehicle 2, such as a steering wheel or a seat.

The vehicle control unit 32 controls each unit of the vehicle 2. The vehicle control unit 32 includes the steering control unit 81, the brake control unit 82, the drive control unit 83, a body system control unit 84, a light control unit 85, and a horn control unit 86.

The steering control unit 81 performs detection, control, and the like of a state of a steering system of the vehicle 2. The steering system includes, for example, a steering mechanism including a steering wheel or the like, an electric power steering, or the like. The steering control unit 81 includes, for example, a steering ECU that controls the steering system, an actuator that drives the steering system, and the like.

The brake control unit 82 performs detection, control, and the like of a state of a brake system of the vehicle 2. The brake system includes, for example, a brake mechanism including a brake pedal or the like, an antilock brake system (ABS), a regenerative brake mechanism, or the like. The brake control unit 82 includes, for example, a brake ECU that controls the brake system, an actuator that drives the brake system, and the like.

The drive control unit 83 performs detection, control, and the like of a state of a drive system of the vehicle 2. The drive system includes, for example, an accelerator pedal, a driving force generation device for generating a driving force such as an internal combustion engine or a driving motor, a driving force transmission mechanism for transmitting the driving force to wheels, or the like. The drive control unit 83 includes, for example, a drive ECU that controls the drive system, an actuator that drives the drive system, and the like.

The body system control unit 84 performs detection, control, and the like of a state of a body system of the vehicle 2. The body system includes, for example, a keyless entry system, a smart key system, a power window device, a power seat, an air conditioner, an airbag, a seat belt, a shift lever, or the like. The body system control unit 84 includes, for example, a body system ECU that controls the body system, an actuator that drives the body system, and the like.

The light control unit 85 performs detection, control, and the like of states of various lights of the vehicle 2. As the lights to be controlled, for example, a headlight, a backlight, a fog light, a turn signal, a brake light, a projection, a bumper display, and the like are assumed. The light control unit 85 includes a light ECU that controls the lights, an actuator that drives the lights, and the like.

The horn control unit 86 performs detection, control, and the like of a state of a car horn of the vehicle 2. The horn control unit 86 includes, for example, a horn ECU that controls the car horn, an actuator that drives the car horn, and the like.

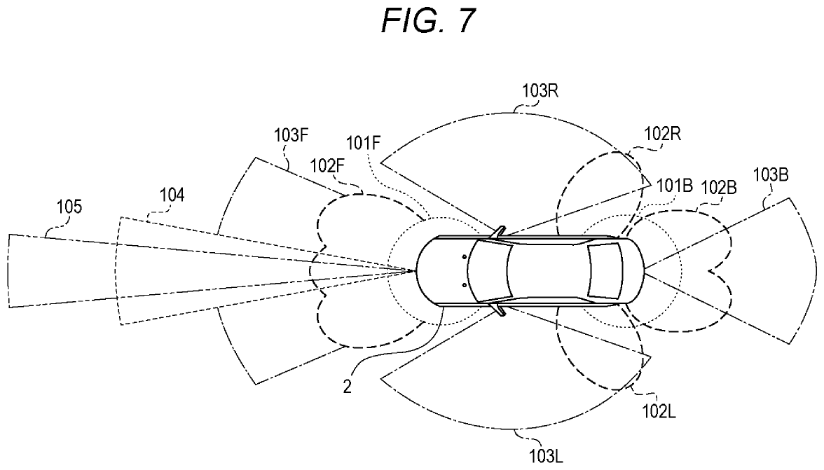

FIG. 7 is a diagram illustrating an example of sensing areas of the camera 51, the radar 52, the LiDAR 53, the ultrasonic sensor 54, and the like of the external recognition sensor 25 in FIG. 6. Note that FIG. 7 schematically illustrates the vehicle 2 as viewed from above, where a left end side is the front end (front) side of the vehicle 2 and a right end side is the rear end (rear) side of the vehicle 2.

Sensing areas 101F and 101B are examples of sensing areas of the ultrasonic sensor 54. The sensing area 101F covers the periphery of the front end of the vehicle 2 by the plurality of ultrasonic sensors 54. The sensing area 101B covers the periphery of the rear end of the vehicle 2 by the plurality of ultrasonic sensors 54.

Sensing results in the sensing areas 101F and 101B are used for, for example, parking assistance and the like of the vehicle 2.

Sensing areas 102F to 102B are examples of sensing areas of the radar 52 for a short range or a medium range. The sensing area 102F covers a position farther than the sensing area 101F, on the front side of the vehicle 2. The sensing area 102B covers a position farther than the sensing area 101B, on the rear side of the vehicle 2. The sensing area 102L covers the rear periphery of a left side surface of the vehicle 2. The sensing area 102R covers the rear periphery of a right side surface of the vehicle 2.

A sensing result in the sensing area 102F is used for, for example, detection and the like of a vehicle, a pedestrian, or the like existing on the front side of the vehicle 2. A sensing result in the sensing area 102B is used for a collision prevention function and the like on the rear side of the vehicle 2, for example. Sensing results in the sensing areas 102L and 102R are used for, for example, detection and the like of an object in a blind spot on the sides of the vehicle 2.

Sensing areas 103F to 103B are examples of sensing areas of the camera 51. The sensing area 103F covers a position farther than the sensing area 102F, on the front side of the vehicle 2. The sensing area 103B covers a position farther than the sensing area 102B, on the rear side of the vehicle 2. The sensing area 103L covers the periphery of the left side surface of the vehicle 2. The sensing area 103R covers the periphery of the right side surface of the vehicle 2.

A sensing result in the sensing area 103F can be used for, for example, recognition of a traffic light or a traffic sign, a lane departure prevention assist system, and an automatic headlight control system. A sensing result in the sensing area 103B is used for, for example, parking assistance, a surround view system, and the like. Sensing results in the sensing areas 103L and 103R can be used for, for example, a surround view system.

A sensing area 104 is an example of a sensing area of the LIDAR 53. The sensing area 104 covers a position farther than the sensing area 103F, on the front side of the vehicle 2. Meanwhile, the sensing area 104 has a narrower range in the left-right direction than the sensing area 103F.

A sensing result in the sensing area 104 is used for, for example, detection of an object such as a neighboring vehicle.

A sensing area 105 is an example of a sensing area of the radar 52 for a long range. The sensing area 105 covers a position farther than the sensing area 104, on the front side of the vehicle 2. Meanwhile, the sensing area 105 has a narrower range in the left-right direction than the sensing area 104.

A sensing result in the sensing area 105 is used for adaptive cruise control (ACC), emergency braking, collision avoidance, and the like, for example.

Note that the respective sensing areas of the sensors, namely, the camera 51, the radar 52, the LiDAR 53, and the ultrasonic sensor 54 included in the external recognition sensor 25 may have various configurations other than those in FIG. 7. Specifically, the ultrasonic sensor 54 may also perform sensing on the sides of the vehicle 2, or the LiDAR 53 may perform sensing on the rear side of the vehicle 2. Furthermore, an installation position of each sensor is not limited to each example described above. Furthermore, the number of each of the sensors may be one or two or more.

### 7. Configuration Example of Recognition Action Management Server

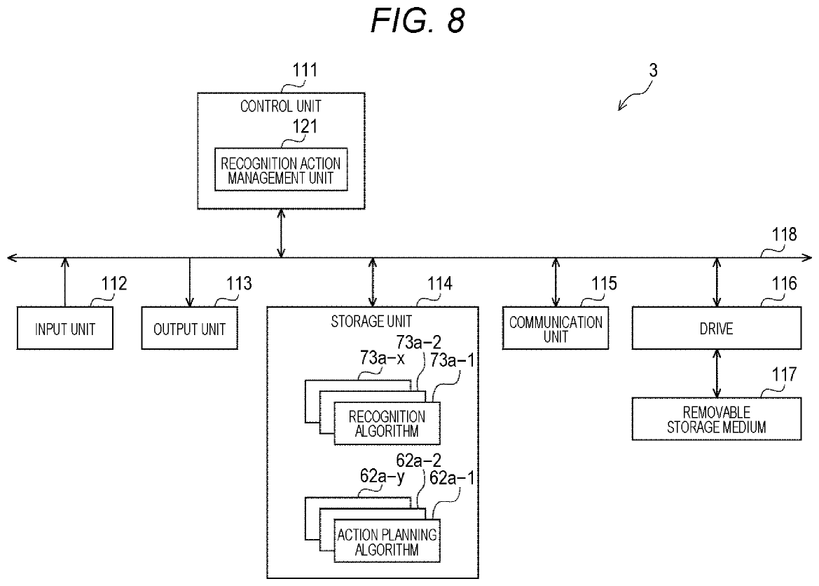

Next, a configuration example of the recognition action management server 3 will be described with reference to FIG. 8.

The recognition action management server 3 includes a control unit 111, an input unit 112, an output unit 113, a storage unit 114, a communication unit 115, a drive 116, and a removable storage medium 117, and is connected to each other via a bus 118, and can transmit and receive data and programs.

The control unit 111 includes a processor and a memory, and controls the entire operation of the recognition action management server 3. Furthermore, the control unit 111 includes a recognition action control unit 121, a recognition unit 122, and an action planning unit 123.

The recognition action control unit 121 controls the communication unit 115 to receive, from the vehicles 2 via the network 4, information regarding a traveling environment corresponding to a position of each of the vehicles 2 and requests for the recognition algorithm 73a and the action planning algorithm 62a corresponding to the traveling environment.

The recognition action control unit 121 searches recognition algorithms 73a-1 to 73a-x and action planning algorithms 62a-1 to 62a-y stored in the storage unit 114 for the recognition algorithm 73a and the action planning algorithm 62a corresponding to the traveling environment in response to the received requests.

Then, the recognition action control unit 121 controls the communication unit 115 to transmit, to the vehicle 2, the searched recognition algorithm 73a and action planning algorithm 62a corresponding to the traveling environment at the position of the vehicle 2.

Basic functions of the recognition unit 122 and the action planning unit 123 are the same as the functions of the recognition unit 73 and the action planning unit 62, and substitute for the functions of the recognition unit 73 and the action planning unit 62 via the network 4 when the recognition algorithm 73a and the action planning algorithm 62a in the recognition unit 73 and the action planning unit 62 are switched.

Note that a default recognition algorithm and a default action planning algorithm each having general predetermined accuracy are provided in the recognition unit 122 and the action planning unit 123 include, but do not correspond to a traveling environment, and have general accuracy.

Furthermore, processing in which the recognition unit 122 and the action planning unit 123 implement the functions of the recognition unit 73 and the action planning unit 62 via the network 4 as substitutes when the recognition algorithm 73a and the action planning algorithm 62a in the recognition unit 73 and the action planning unit 62 are switched will be described later in detail in an application example to be described later.

The input unit 112 includes an input device such as a keyboard, a mouse, or a touch panel through which an operation command is input, and supplies various input signals to the control unit 111.

The output unit 113 is controlled by the control unit 111 and includes a display unit and a voice output unit. The output unit 113 outputs an operation screen and an image of a processing result to the display unit including a display device configured by a liquid crystal display (LCD), an organic electro luminescence (EL), or the like for display. Furthermore, the output unit 113 controls the voice output unit including a voice output device to output various voices.

The storage unit 114 includes a hard disk drive (HDD), a solid state drive (SSD), a semiconductor memory, or the like, and is controlled by the control unit 111 to write or read various types of data including content data and programs.

The storage unit 114 stores, in advance, the recognition algorithms 73a-1 to 73a-x to be used by the recognition unit 73 and the action planning algorithms 62a-1 to 62a-y to be used by the action planning unit 62, the algorithms corresponding to various traveling environments.

The communication unit 115 is controlled by the control unit 111, implements communication represented by a local area network (LAN), Bluetooth (registered trademark), or the like in a wired or wireless manner, and transmits and receives various data and programs to and from various apparatuses via a network 33 as necessary.

The drive 116 reads and writes data from and to the removable storage medium 117 such as a magnetic disk (including a flexible disk), an optical disk (including a compact disc-read only memory (CD-ROM) and a digital versatile disc (DVD)), a magneto-optical disk (including a mini disc (MD)), a semiconductor memory, or the like.

### <Algorithm Optimization Processing in Automated Driving Control System in FIG. 5>

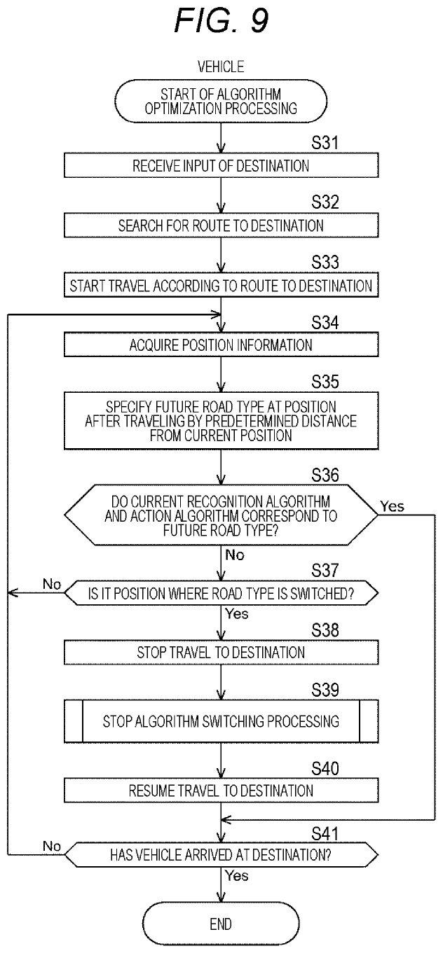

Next, algorithm optimization processing in the automated driving control system 1 in FIG. 5 will be described with reference to flowcharts in FIGS. 9 to 11.

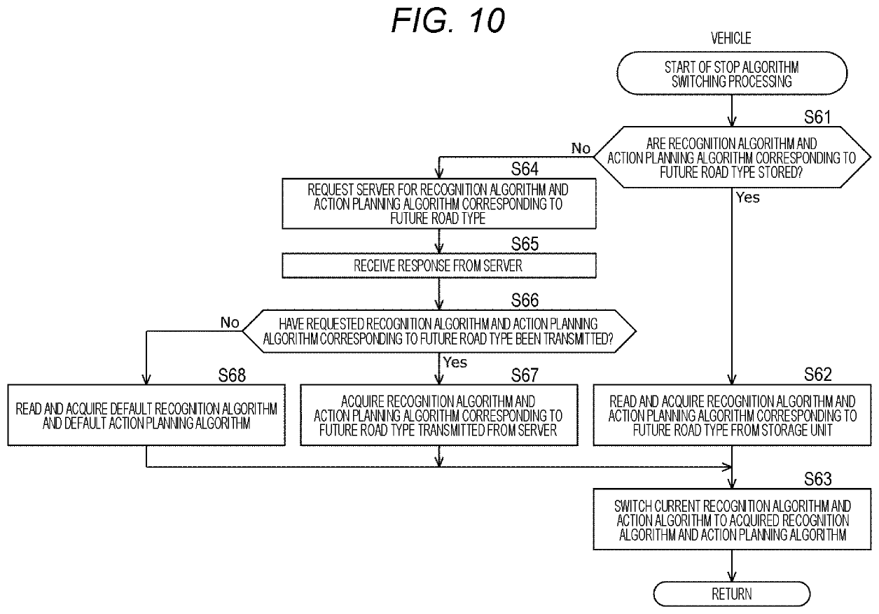

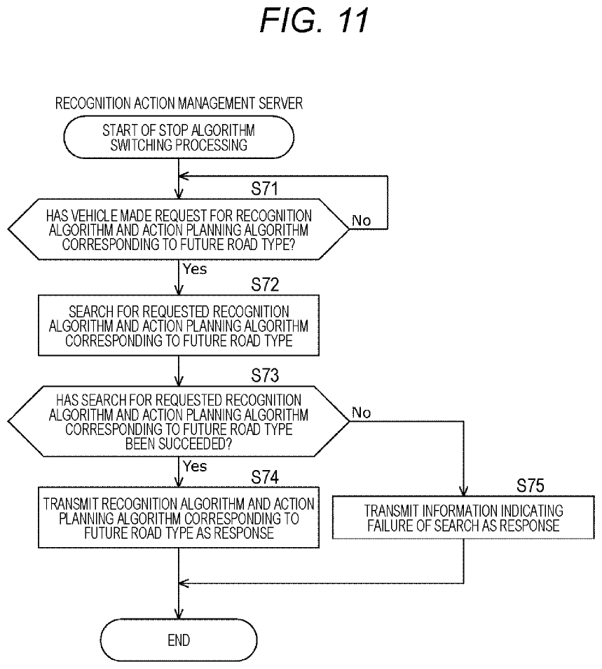

Note that the flowcharts in FIGS. 9 and 10 are flowcharts for describing processing in the vehicle 2, and the flowchart of FIG. 11 is a flowchart for describing processing in the recognition action management server 3.

In step S31, the action planning unit 62 acquires information regarding a destination input through the HMI 31 operated by a driver or an occupant.

In step S32, the action planning unit 62 acquires position information of the vehicle 2 supplied from the position information acquisition unit 24 as a current position (start position), and searches for a travel route (route) in which the destination input through the HMI 31 operated by the driver or the occupant is set as a goal from the current position. Then, the action planning unit 62 supplies information regarding the travel route (route) to the destination as a search result to the operation control unit 63 and the recognition action control unit 64.

In step S33, the operation control unit 63 operates the vehicle 2 to achieve an action plan corresponding to the planned route (route) supplied from the action planning unit 62 and move toward the destination.

In step S34, the recognition action control unit 64 acquires the position information of the vehicle 2 supplied from the position information acquisition unit 24 as information regarding the current position.

In step S35, the recognition action control unit 64 reads a high-precision map currently accumulated in the map information accumulation unit 23, and specifies, as a future road type, a road type at a position after traveling for a predetermined time from the current position along the travel route (route) from the position information of the vehicle 2 supplied from the position information acquisition unit 24 to the destination.

In step S36, the recognition action control unit 64 determines whether or not the recognition algorithm 73a of the recognition unit 73 and the action planning algorithm 62a of the action planning unit 62 are algorithms each corresponding to the future road type.

For example, in a case where each of the recognition algorithm 73a of the recognition unit 73 and the action planning algorithm 62a of the action planning unit 62 corresponds to a forest road or a mountain road, as a road type, and the future road type is a residential area, current algorithms are not algorithms corresponding to the future road type.

Therefore, in such a case, in the process of step S36, it is considered that the current recognition algorithm 73a of the recognition unit 73 and the current action planning algorithm 62a of the action planning unit 62 are not the algorithms corresponding to the future road type, and the processing proceeds to step S37.

In step S37, the recognition action control unit 64 determines whether or not the current position is a position where the road type is switched. In a case where it is determined in step S37 that the current position is not the position where the road type is switched, the processing returns to step S34. That is, in a case where the current recognition algorithm 73a of the recognition unit 73 and the current action planning algorithm 62a of the action planning unit 62 are not the algorithms corresponding to the future road type, the processes in steps S34 to S37 are repeated until the current position becomes the position where the road type is switched.

Then, when the vehicle 2 continues to move toward the destination and the current position reaches the position where the road type is switched, it is determined in step S37 that the current position is the position where the road type is switched, and the processing proceeds to step S38.

In step S38, the recognition action control unit 64 controls the operation control unit 63 to stop the movement of the vehicle 2.

In step S39, the recognition action control unit 64 executes stop algorithm switching processing to switch the recognition algorithm 73a of the recognition unit 73 and the action planning algorithm 62a of the action planning unit 62 to the algorithms corresponding to the future road type to which switching is performed.

Note that details of the stop algorithm switching processing will be described later with reference to the flowchart of FIG. 10.

In step S40, the recognition action control unit 64 controls the operation control unit 63 to resume the movement of the vehicle 2 to the destination.

In step S41, the recognition action control unit 64 reads position information of the vehicle 2 supplied from the position information acquisition unit 24 as a current position, determines whether or not the vehicle has arrived at the destination. In a case where the vehicle has not arrived at the destination, the processing returns to step S34, and the subsequent processes are repeated.

Furthermore, in the process in step S36, in a case where it is considered that the current recognition algorithm 73a of the recognition unit 73 and the current action planning algorithm 62a of the action planning unit 62 correspond to the future road type, it is not necessary to switch the recognition algorithm 73a of the recognition unit 73 and the action planning algorithm 62a of the action planning unit 62, and thus, the processes in steps S37 to S40 are skipped, and the processing proceeds to step S41.

That is, it is determined whether or not the current recognition algorithm 73a of the recognition unit 73 and the current action planning algorithm 62a of the action planning unit 62 correspond to the future road type. In a case where the algorithms do not correspond to the future road type, the algorithms are switched and changed.

Furthermore, in a case where the current recognition algorithm 73a of the recognition unit 73 and the current action planning algorithm 62a of the action planning unit 62 correspond to the future road type, the current recognition algorithm 73a of the recognition unit 73 and the current action planning algorithm 62a of the action planning unit 62 are continuously used.

Then, the processing ends in a case where it is determined in step S41 that the current position is the destination and the vehicle has arrived at the destination.

Through the above processing, when the destination is set by the occupant or the driver, the travel route to the destination is planned, the automated driving is started, and the future road type at the position after traveling by a predetermined distance is specified when the vehicle 2 moves by the automated driving along the planned travel route.

At this time, it is determined whether or not the recognition algorithm 73a of the recognition unit 73 and the action planning algorithm 62a of the action planning unit 62 are the algorithms each corresponding to the specified road type. In a case where the algorithms are not the corresponding algorithms, switching to the corresponding algorithms is performed at the position where the road type is switched.

Therefore, even if the road type changes due to the movement accompanying the automated driving, the recognition algorithm 73a of the recognition unit 73 and the action planning algorithm 62a of the action planning unit 62 are changed to optimal algorithms in accordance with the road type.

As a result, the algorithms related to the object recognition processing and the action planning processing are optimized in accordance with a change in a traveling environment, so that safety, travel quality, and efficiency related to the automated driving can be improved.

### <Stop Algorithm Switching Processing in Vehicle>

Next, stop algorithm switching processing in the vehicle 2 will be described with reference to the flowchart of FIG. 10.

In step S61, the recognition action control unit 64 accesses the storage unit 28, searches the stored recognition algorithms 73a-1 to 73a-n and action planning algorithms 62a-1 to 62a-m for the recognition algorithm 73a and the action planning algorithm 62a corresponding to a future road type, and determines whether or not the recognition algorithm 73a and the action planning algorithm 62a corresponding to the future road type are stored in the storage unit 28.

In a case where it is determined in step S61 that the recognition algorithm 73a and the action planning algorithm 62a corresponding to the future road type are stored in the storage unit 28, the processing proceeds to step S62.

In step S62, the recognition action control unit 64 reads and acquires the searched recognition algorithm 73a and action planning algorithm 62a corresponding to the future road type from the storage unit 28.

In step S63, the recognition action control unit 64 switches and changes the recognition algorithm 73a of the recognition unit 73 and the action planning algorithm 62a of the action planning unit 62 to the searched recognition algorithm 73a and the action planning algorithm 62a corresponding to the future road type.

On the other hand, in a case where it is determined in step S61 that the recognition algorithm 73a and the action planning algorithm 62a corresponding to the future road type are not stored in the storage unit 28, the processing proceeds to step S64.

In step S64, the recognition action control unit 64 controls the communication unit 22 to access the recognition action management server 3 via the network 4, and makes a request for the recognition algorithm 73a and the action planning algorithm 62a corresponding to the future road type.

### <Stop Algorithm Switching Processing in Recognition Action Management Server>

Here, stop algorithm switching processing in the recognition action management server 3 will be described with reference to the flowchart of FIG. 11.

In step S71, the recognition action control unit 121 in the control unit 111 of the recognition action management server 3 controls the communication unit 115 to determine whether or not the vehicle 2 has made a request for the recognition algorithm 73a and the action planning algorithm 62a corresponding to the future road type via the network 4, and repeats similar processing until it is determined that the request has been made.

In a case where it is determined in step S71 that the vehicle 2 has made the request for the recognition algorithm 73a and the action planning algorithm 62a corresponding to the future road type, the processing proceeds to step S72.

In step S72, the recognition action control unit 121 accesses the storage unit 114, and searches the stored recognition algorithms 73a-1 to 73a-x and action planning algorithms 62a-1 to 62a-y for the recognition algorithm 73a and the action planning algorithm 62a corresponding to the future road type for which the request from the vehicle 2 has been made.

In step S73, the recognition action control unit 121 determines whether or not the recognition algorithm 73a and the action planning algorithm 62a corresponding to the future road type for which the request from the vehicle 2 has been made are successfully searched from among the recognition algorithms 73a-1 to 73a-x and action planning algorithms 62a-1 to 62a-y stored in the storage unit 114.

In a case where it is determined in step S73 that the recognition algorithm 73a and the action planning algorithm 62a corresponding to the future road type for which the request from the vehicle 2 has been made are successfully searched from among the recognition algorithms 73a-1 to 73a-x and the action planning algorithms 62a-1 to 62a-y stored in the storage unit 114, the processing proceeds to step S74.

In step S74, the recognition action control unit 121 controls the communication unit 115 to transmit the searched recognition algorithm 73a and action planning algorithm 62a as a response to the vehicle 2 via the network 4.

On the other hand, in a case where it is determined in step S73 that the search has failed for the recognition algorithm 73a and the action planning algorithm 62a corresponding to the future road type for which the request from the vehicle 2 has been made from among the recognition algorithms 73a-1 to 73a-x and the action planning algorithms 62a-1 to 62a-y stored in the storage unit 114, the processing proceeds to step S75.

In step S75, the recognition action control unit 121 controls the communication unit 115 to transmit, to the vehicle 2 via the network 4, a response indicating the failure of the search for the recognition algorithm 73a and the action planning algorithm 62a corresponding to the future road type for which the request has been made.

Through the above processing, in a case where the vehicle 2 has made a request for the recognition algorithm 73a and the action planning algorithm 62a corresponding to the future road type, the recognition action management server 3 searches for the corresponding recognition algorithm 73a and action planning algorithm 62a corresponding to the future road type.

Then, the searched recognition algorithm 73a and action planning algorithm 62a corresponding to the future road type are transmitted to the vehicle 2 as a response in a case where the search has succeeded, and information indicating the failure of the search is transmitted to the vehicle 2 as a response in a case where the search fails.

Therefore, even in a case where the recognition algorithm 73a and the action planning algorithm 62a corresponding to the future road type are not stored in the own storage unit 28, the vehicle 2 can acquire the corresponding algorithms when the corresponding algorithms are stored in the recognition action management server 3.

Here, the description returns to the flowchart of FIG. 10.

In step S65, the recognition action control unit 64 controls the communication unit 22 to receive the response transmitted from the recognition action management server 3 via the network 4.

In step S66, the recognition action control unit 64 determines whether or not the requested recognition algorithm 73a and action planning algorithm 62a corresponding to the future road type have been transmitted as the response from the recognition action management server 3.

In step S66, in a case where the recognition action control unit 64 controls the communication unit 22 and determines that the recognition algorithm 73a and the action planning algorithm 62a corresponding to the future road type have been transmitted from the recognition action management server 3, the processing proceeds to step S67.

In step S67, the recognition action control unit 64 controls the communication unit 22 to acquire the recognition algorithm 73a and the action planning algorithm 62a corresponding to the future road type transmitted from the recognition action management server 3, and the processing proceeds to step S63.

On the other hand, in step S66, in a case where the recognition action control unit 64 determines that the requested recognition algorithm 73a and action planning algorithm 62a corresponding to the future road type have not been transmitted as the response from the recognition action management server 3, that is, the response indicating the failure of the search has been transmitted, the processing proceeds to step S68.

In step S68, the recognition action control unit 64 accesses the storage unit 28, reads and acquires the generally used default recognition algorithm 73a and action planning algorithm 62a from among the recognition algorithms 73a-1 to 73a-n and the action planning algorithms 62a-1 to 62a-m, and the processing proceeds to step S63.

That is, through the above processing, in a case where the recognition algorithm 73a and the action planning algorithm 62a corresponding to the future road type are stored in the storage unit 28, the corresponding recognition algorithm 73a and action planning algorithm 62a are read from the storage unit 28, and are switched to be used by the recognition unit 73 and the action planning unit 62.

Furthermore, in a case where the recognition algorithm 73a and the action planning algorithm 62a corresponding to the future road type are not stored in the storage unit 28, the request for the recognition algorithm 73a and the action planning algorithm 62a corresponding to the future road type is made with respect to the recognition action management server 3 via the network 4.

Then, when the recognition algorithm 73a and the action planning algorithm 62a corresponding to the future road type are searched and supplied from the recognition action management server 3, the recognition algorithm 73a and the action planning algorithm 62a corresponding to the future road type are acquired and switched to be used by the recognition unit 73 and the action planning unit 62.

Moreover, when the recognition algorithm 73a and the action planning algorithm 62a corresponding to the future road type are not supplied from the recognition action management server 3, that is, when the search has failed in the recognition action management server 3, the default recognition algorithm 73a and the default action planning algorithm 62a stored in the storage unit 28 are switched to be used by the recognition unit 73 and the action planning unit 62.

By the series of processing described above, even if the road type changes due to the movement accompanying the automated driving, the recognition algorithm 73a of the recognition unit 73 and the action planning algorithm 62a of the action planning unit 62 are changed to optimal algorithms in accordance with the road type as the traveling environment.

As a result, the algorithms related to the object recognition processing in the recognition unit 73 and the travel planning processing in the action planning unit 62 are optimized in accordance with a change in the traveling environment, so that the safety, travel quality, and efficiency related to the automated driving can be improved.

Note that the example in which at least any of the recognition algorithm 73a of the recognition unit 73 and the action planning algorithm 62a of the action planning unit 62 is switched in accordance with the traveling environment specified on the basis of the position information has been described as above.

That is, as described with reference to FIGS. 2 and 3, the example in which the recognition algorithm 73a and the action planning algorithm 62a are switched in accordance with the level of the occurrence frequency of the obstacle and the like has been described.

However, the traveling environment changes depending on not only the position information but also the date and time, the season, and the like as described with reference to FIG. 4.

Therefore, the traveling environment may be specified on the basis of not only the position information but also the date and time, the season, the weather, the presence or absence of a large-scale event (a festival, a sports tournament, an exhibition, or the like), the presence or absence of a trouble in public transportation (suspension, delay, or the like), and the like as described above.

Furthermore, the recognition algorithm 73a and the action planning algorithm 62a may also be switched to appropriate algorithms according to the traveling environment by preparing not only those corresponding to the traveling environment depending on the position information but also those corresponding to the traveling environment specified on the basis of the date and time, the season, and the weather, the presence or absence of a large-scale event (a festival, a sports tournament, an exhibition, or the like), the presence or absence of a trouble in public transportation (suspension, delay, or the like), and the like.

Therefore, in the process of step S37 described above, for example, the stop algorithm switching processing may be performed depending on whether or not the date and time, season, weather, and the like specifying the traveling environment as well as the road type change.

Moreover, at a point in time when a destination is set and a travel route from the start to the goal is planned, a traveling environment generated during travel may be specified in advance, and all necessary recognition algorithms 73a and action planning algorithms 62a may be downloaded from the recognition action management server 3 and stored in the storage unit 28 before starting the travel.

As a result, for example, even in a situation where communication is disabled during travel, it is possible to perform the travel while reliably switching the recognition algorithm 73a and the action planning algorithm 62a to appropriate ones according to the traveling environment.

Furthermore, at a point in time when a destination is set and a travel route from the start to the goal is planned, all necessary recognition algorithms 73a and action planning algorithms 62a may be downloaded from the recognition action management server 3 and stored in the storage unit 28 before starting the travel on the basis of a history of past travel routes.

Moreover, the example in which the algorithms are switched by performing the stop algorithm switching processing after the vehicle 2 temporarily stops at the position where the road type, that is, the traveling environment changes has been described as above, but the stop algorithm switching processing may be performed at a stop timing due to congestion, waiting for a traffic light, stop at a railroad crossing, or the like within a predetermined distance from the position where the traveling environment changes.

### 8. Application Example

The example in which travel of the vehicle 2 to the destination is temporarily stopped at the position where the road type is switched, and the recognition algorithm 73a and the action planning algorithm 62a of the recognition unit 73 and the action planning unit 62 are switched to the algorithms corresponding to the future road type in the stopped state, and then, the travel to the destination is resumed has been described as above.

However, a switching zone may be set immediately before switching to a new road type, and the recognition unit 122 and the action planning unit 123 of the recognition action management server 3 may be caused to perform processing in the recognition unit 73 and processing in the action planning unit 62 as substitutes in the switching zone. Alternatively, a cloud computer (not illustrated) connected to the network 4 may be caused to perform the processing in the recognition unit 73 and the processing in the action planning unit 62 as a substitute.

Then, in the switching zone, the recognition algorithm 73a and the action planning algorithm 62a of the recognition unit 73 and the action planning unit 62 may be switched to the algorithms corresponding to the future road type in a state where the travel to the destination is continued.

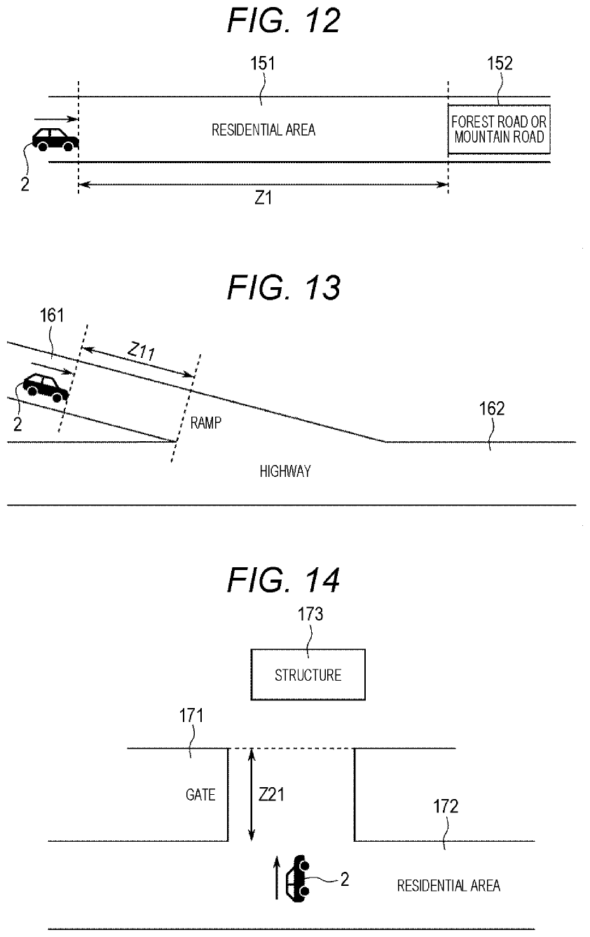

For example, as illustrated in FIG. 12, a case where a road type changes to a forest road or mountain road 152 as a future traveling environment in a case where the vehicle 2 is traveling in a residential area 151 in the right direction in the drawing as indicated by an arrow will be considered.

In preparation for such a case, the functions of the recognition unit 73 and the action planning unit 62 can be implemented by the recognition action management server 3 or the cloud computer (not illustrated).

Then, while the vehicle 2 is traveling in a switching zone Z1, the recognition algorithm 73a and the action planning algorithm 62a corresponding to the forest road or mountain road 152, which is the future road type, may be searched for and acquired from the storage unit 28, or may be requested with respect to the recognition action management server 3 and acquired to switch algorithms.

Furthermore, as illustrated in FIG. 13, in a case where the vehicle 2 enters a highway 162, which is the future road type, from a ramp 161 as indicated by an arrow, the recognition action management server 3 or the cloud computer (not illustrated) substitutes for the recognition unit 73 and the action planning unit 62 to perform the processing while the vehicle 2 is traveling in a switching zone Z11 in the ramp 161 before the highway 162. Then, while the vehicle 2 is traveling in the switching zone Z11, algorithms corresponding to the highway 162 as the future road type may be acquired to switch algorithms.

Moreover, as illustrated in FIG. 14, a case will be considered in which the vehicle 2 passes through a gate 171 from a general road 172 and enters private land in or near a site of a structure 173 such as an apartment or a factory, which is the future road type, above a dotted line in the drawing.

In such a case, when the vehicle 2 passes through a switching zone Z21 in the gate 171, the recognition action management server 3 or the cloud computer (not illustrated) having the corresponding functions substitutes for the recognition unit 73 and the action planning unit 62 to perform the processing. Then, while the vehicle 2 is traveling in the switching zone Z21, algorithms corresponding to the private land in or near the site of the structure 173 such as an apartment or a factory, which is the future road type, may be acquired to switch algorithms.

Note that, for example, in a case where the switching zones Z1, Z11, and Z21 described with reference to FIGS. 12 to 14 cannot be set, the travel to the destination may be stopped at the position where the road type is switched as described above, algorithms may be switched and changed by the stop algorithm switching processing, and then, the travel to the destination may be resumed.

### <Application Example of Algorithm Optimization Processing>

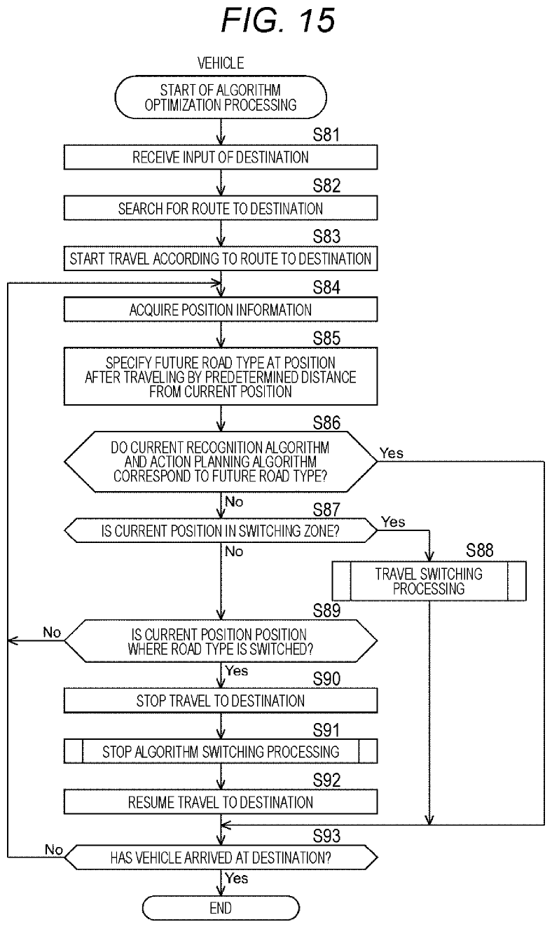

Next, an application example of the algorithm optimization processing will be described with reference to a flowchart of FIG. 15.

Note that processes in steps S81 to S86 and steps S91 to S94 of FIG. 15 are similar to the processes in steps S31 to S36 and steps S38 to S41 in the flowchart of FIG. 9, and thus, the description thereof is appropriately omitted.

That is, when it is determined in step S86 that current algorithms do not correspond to a future road type, the processing proceeds to step S87.

In step S87, the recognition action control unit 64 determines whether or not a current position is within a switching zone.

In step S87, the current position is considered to be in the switching zone, for example, in the case of being in the switching zone Z1, Z11, or Z21 in FIGS. 12 to 14, and the processing proceeds to step S88.

In step S88, the recognition action control unit 64 executes travel algorithm switching processing to switch the recognition algorithm 73a of the recognition unit 73 and the action planning algorithm 62a of the action planning unit 62 to algorithms corresponding to a road type to be switched

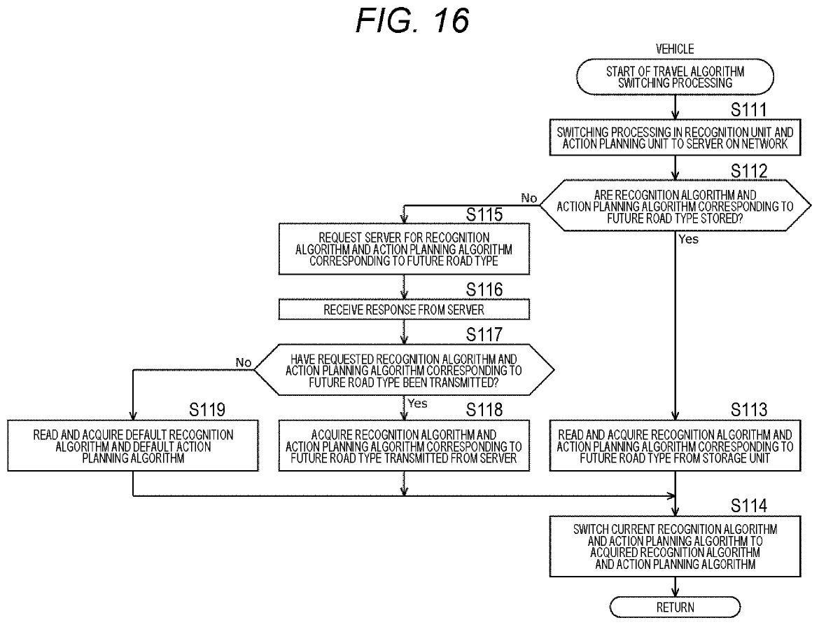

Note that details of the travel algorithm switching processing will be described later with reference to a flowchart of FIG. 16.

Furthermore, in a case where it is determined in step S87 that the current position is not within the switching zone, the processing proceeds to step S89.

In step S89, the recognition action control unit 64 determines whether or not the current position is a position where the road type is switched. Then, in a case where it is determined in step S89 that it is not the position where the road type is switched, the processing returns to step S87.

That is, in a case where the recognition algorithm 73a and the action planning algorithm 62a do not correspond to the future road type, travel to a destination is continued and the travel algorithm switching processing is performed when the current position enters the switching zone, and the process of switching to the algorithms corresponding to the future road type is performed.

Then, in step S89, in a case where the current position reaches the position where the road type is switched in a state where the switching to the algorithms corresponding to the future road type is not completed, that is, without the setting of the switching zone, the processing proceeds to step S90.

Then, by the processes in steps S90 to S92, the stop algorithm switching processing is performed to stop the travel of the vehicle 2 to the destination and switch to the algorithms corresponding to the future road type.

Through the above processing, when the destination is set by the occupant or the driver, the travel route to the destination is planned, the automated driving is started, and the future road type at the position after traveling by a predetermined distance is specified when the vehicle 2 moves by the automated driving along the planned travel route.

At this time, it is determined whether or not the recognition algorithm 73a of the recognition unit 73 and the action planning algorithm 62a of the action planning unit 62 are the algorithms each corresponding to the specified road type. In a case where the algorithms are not the corresponding algorithms, the travel algorithm switching processing is performed in a state where the travel is continued when the current position enters the switching zone.

Then, the travel is continued as it is in a case where the recognition algorithm 73a of the recognition unit 73 and the action planning algorithm 62a of the action planning unit 62 are switched to the algorithms corresponding to the future road type by the travel algorithm switching processing.

On the other hand, in a case where there is no setting of the switching zone, and the recognition algorithm 73a of the recognition unit 73 and the action planning algorithm 62a of the action planning unit 62 cannot be switched to the algorithms corresponding to the future road type by the travel algorithm switching processing, the travel of the vehicle 2 to the destination is stopped, and then, the stop algorithm switching processing described above is performed to switch the algorithms.

Therefore, even if the road type changes due to the movement accompanying the automated driving, the recognition algorithm 73a of the recognition unit 73 and the action planning algorithm 62a of the action planning unit 62 are changed to optimal algorithms in accordance with the road type with the traveling state being continued.

Furthermore, at this time, in a case where the recognition algorithm 73a of the recognition unit 73 or the action planning algorithm 62a of the action planning unit 62 cannot be changed to the optimal algorithms with the traveling state being continued, the travel of the vehicle 2 is stopped and the algorithms are reliably switched by the stop algorithm switching processing.

As a result, the algorithms related to the object recognition processing and the travel planning processing are optimized in accordance with a change in the traveling environment while maintaining a synergistic state to the destination, so that the safety, travel quality, and efficiency related to the automated driving can be improved.

### <Application Example of Travel Algorithm Switching Processing>

Next, an application example of the travel algorithm switching processing in the vehicle 2 will be described with reference to the flowchart of FIG. 16. Note that processes in steps S112 to S119 in the flowchart of FIG. 16 are similar to the processes in steps S61 to S68 in the flowchart of FIG. 10, and thus, the description thereof is appropriately omitted.

In step S111, the recognition action control unit 64 controls the communication unit 22 for the processing in the recognition unit 73 and the action planning unit 62 to cause the recognition action management server 3 or the cloud computer (not illustrated) to perform the processing in the recognition unit 73 and the action planning unit 62 on the network 4 as substitutes in a switched manner.

Then, by processes in steps S112 and S113, the recognition algorithm 73a of the recognition unit 73 and the action planning algorithm 62a of the action planning unit 62 are switched to the recognition algorithm 73a and the action planning algorithm 62a which correspond to a future road type and are stored in the storage unit 28.

Furthermore, by processes in steps S115 to S118, in a case where the recognition algorithm 73a and the action planning algorithm 62a corresponding to the future road type are not stored in the storage unit 28, switching is made to the recognition algorithm 73a and the action planning algorithm 62a which correspond to the future road type and are searched and supplied from the recognition action management server 3.

Moreover, in step S117, in a case where the requested recognition algorithm 73a and action planning algorithm 62a corresponding to the future road type are not searched, the algorithms of the recognition unit 73 and the action planning unit 62 are switched to the default recognition algorithm 73a and the default action planning algorithm 62a by a process in step S119. Note that the processing in the recognition action management server 3 is similar to the stop algorithm switching processing described with reference to the flowchart of FIG. 11, and thus, the description thereof is omitted.

Through the above processing, when switching of the algorithms of the recognition unit 73 and the action planning unit 62 is performed, the functions of the recognition unit 73 and the action planning unit 62 are substituted by the recognition action management server 3 or the cloud computer (not illustrated) on the network 4, so that the algorithms of the recognition unit 73 and the action planning unit 62 can be optimized to the algorithms corresponding to the future road type, which is the future traveling environment, with the travel state being continued.

As a result, the algorithms related to the object recognition processing in the recognition unit 73 and the travel planning processing in the action planning unit 62 are optimized in accordance with a change in the traveling environment, so that the safety, travel quality, and efficiency related to the automated driving can be improved.

### 9. Example of Execution by Software

Incidentally, the series of processing described above can be executed by hardware, but can also be executed by software. In a case where the series of processing is executed by software, a program constituting the software is installed from a recording medium into, for example, a computer built into dedicated hardware or a general-purpose computer that is capable of executing various functions by installing various programs, or the like.

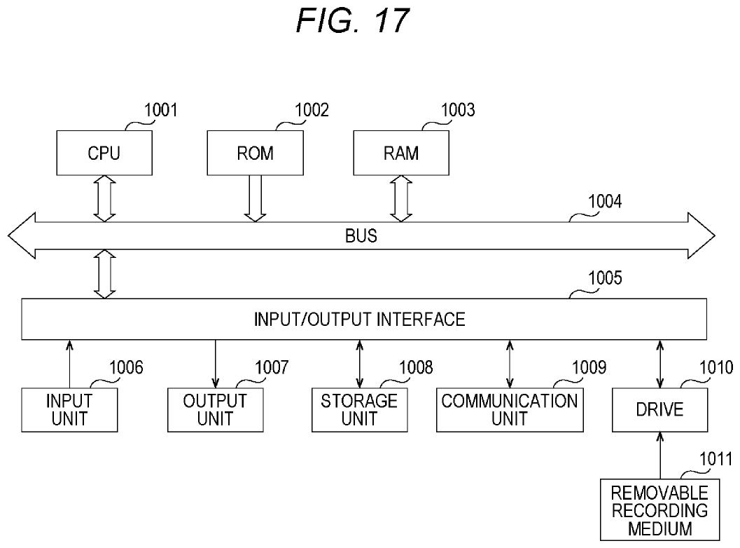

FIG. 17 is a diagram illustrating a configuration example of a general-purpose computer. This computer includes a central processing unit (CPU) 1001. An input/output interface 1005 is connected to the CPU 1001 via a bus 1004. A read only memory (ROM) 1002 and a random access memory (RAM) 1003 are connected to the bus 1004.

The input/output interface 1005 is connected with an input unit 1006 including an input device such as a keyboard and a mouse to be inputted with an operation command by a user, an output unit 1007 that outputs a processing operation screen or an image of a processing result to a display device, a storage unit 1008 including, for example, a hard disk drive that stores programs and various data, and a communication unit 1009 that includes a local area network (LAN) adapter and the like and executes communication processing via a network represented by the Internet. Furthermore, a drive 1010 that reads and writes data from and to a removable storage medium 1011 such as a magnetic disk (including flexible disk), an optical disk (including compact disc-read only memory (CD-ROM) and digital versatile disc (DVD)), a magneto-optical disk (including Mini Disc (MD)), or a semiconductor memory is connected.

The CPU 1001 executes various processes in accordance with a program stored in the ROM 1002, or a program read from the removable storage medium 1011 such as a magnetic disk, an optical disk, a magneto-optical disk, or semiconductor memory, installed in the storage unit 1008, and loaded from the storage unit 1008 into the RAM 1003. Furthermore, the RAM 1003 also appropriately stores data necessary for the CPU 1001 to execute various processes, and the like.

In the computer configured as described above, for example, the CPU 1001 loads the program stored in the storage unit 1008 into the RAM 1003 via the input/output interface 1005 and the bus 1004 and executes the program, to thereby perform the above-described series of processing.

The program executed by the computer (CPU 1001) can be provided by being recorded in the removable storage medium 1011 as a package medium or the like, for example. Furthermore, the program can be provided via a wired or wireless transmission medium such as a local area network, the Internet, or digital satellite broadcasting.

In the computer, the program can be installed in the storage unit 1008 via the input/output interface 1005 by mounting the removable storage medium 1011 to the drive 1010. Furthermore, the program can be received by the communication unit 1009 via a wired or wireless transmission medium and installed in the storage unit 1008. In addition, the program can be installed in the ROM 1002 or the storage unit 1008 in advance.

Note that the program executed by the computer may be a program that executes processing in time series in the order described in the present description, or a program that executes processing in parallel or at a necessary timing such as when a call is made.

Note that the CPU 1001 in FIG. 17 implements the functions of the travel assistance/automated driving control unit 29 in FIG. 6.

Furthermore, in the present specification, a system is intended to mean assembly of a plurality of components (apparatuses, modules (parts), and the like) and it does not matter whether or not all the components are in the same housing. Therefore, a plurality of apparatuses accommodated in separate housings and connected via a network and one apparatus in which a plurality of modules is accommodated in one housing are both systems.

Note that embodiments of the present disclosure are not limited to the embodiments described above, and various modifications may be made without departing from the scope of the present disclosure.

For example, the present disclosure can have a configuration of cloud computing in which one function is shared by a plurality of apparatuses via a network and processing is performed in cooperation.

Furthermore, each of the steps described in the flowcharts described above can be executed by one apparatus or executed by a plurality of apparatuses in a shared manner.

Moreover, in a case where a plurality of processes is included in one step, the plurality of the processes included in the one step can be executed by one apparatus or by a plurality of apparatuses in a shared manner.

Note that the present disclosure may also have the following configurations.
<1> An information processing apparatus including:
a recognition unit that has a recognition algorithm for recognizing an obstacle and recognizes the obstacle by the recognition algorithm on the basis of sensor information;
an action planning unit that has an action planning algorithm for planning a travel route, and plans the travel route of a mobile apparatus by the action planning algorithm; and
a recognition action control unit that performs control to switch at least any of the recognition algorithm and the action planning algorithm on the basis of a traveling environment of the mobile apparatus.
<2> The information processing apparatus according to <1>, further including
a storage unit that stores at least any of a plurality of the recognition algorithms according to the traveling environment and a plurality of the action planning algorithms according to the traveling environment, in which
the recognition action control unit searches the storage unit for at least any of the recognition algorithm and the action planning algorithm corresponding to the traveling environment, and performs control to switch at least any of the recognition algorithm of the recognition unit and the action planning algorithm of the action planning unit to the searched recognition algorithm and the searched action planning algorithm.
<3> The information processing apparatus according to <1> or <2>, further including
a position information acquisition unit that acquires current position information of the information processing apparatus, in which
the recognition action control unit specifies the traveling environment on the basis of the position information, and performs control to switch at least any of the recognition algorithm and the action planning algorithm on the basis of the specified traveling environment.
<4> The information processing apparatus according to <3>, further including
a map information accumulation unit that accumulates map information in which a traveling environment is recorded for each position information, in which
the recognition action control unit specifies the traveling environment corresponding to the position information on the basis of the map information accumulated in the map information accumulation unit.
<5> The information processing apparatus according to <4>, in which
the recognition action control unit performs control, on the basis of the map information accumulated in the map information accumulation unit, to switch at least any of the recognition algorithm of the recognition unit and the action planning algorithm of the action planning unit to the recognition algorithm and the action planning algorithm that correspond to a new traveling environment at a position where the traveling environment corresponding to the position information changes.
<6> The information processing apparatus according to <5>, in which
the recognition action control unit performs control, on the basis of the map information accumulated in the map information accumulation unit, to stop the mobile apparatus and switch at least any of the recognition algorithm of the recognition unit and the action planning algorithm of the action planning unit to the recognition algorithm and the action planning algorithm that correspond to the new traveling environment at the position where the traveling environment corresponding to the position information changes.
<7> The information processing apparatus according to <5>, in which
a switching zone is set at a position a predetermined distance before the position where the traveling environment changes, and
the recognition action control unit controls to switch at least any of the recognition algorithm of the recognition unit and the action planning algorithm of the action planning unit to the recognition algorithm and the action planning algorithm that correspond to the new traveling environment while moving the mobile apparatus when the mobile apparatus is within the switching zone.
<8> The information processing apparatus according to <7>, in which
the recognition action control unit controls to switch at least any of the recognition algorithm of the recognition unit and the action planning algorithm of the action planning unit to the recognition algorithm and the action planning algorithm that correspond to the new traveling environment while moving the mobile apparatus by causing an external server to substitute for a function of at least any of the recognition unit and the action planning unit when the mobile apparatus is in the switching zone.
<9> The information processing apparatus according to <8>, in which
the external server is a cloud computer that is capable of substituting for functions of the recognition unit and the action planning unit.
<10> The information processing apparatus according to any one of <1> to <9>, in which
the recognition action control unit specifies the traveling environment on the basis of date and time or weather, and performs control to switch at least any of the recognition algorithm and the action planning algorithm on the basis of the specified traveling environment.
<11> The information processing apparatus according to any one of <1> to <10>, in which
the recognition action control unit
performs control to switch the recognition algorithm of the recognition unit to a recognition algorithm for turning on processing of recognizing a predetermined obstacle in a case where an existence probability of the predetermined obstacle is higher than a predetermined value in accordance with the traveling environment, and
performs control to switch the recognition algorithm of the recognition unit to a recognition algorithm for turning off the processing of recognizing the predetermined obstacle in a case where the existence probability of the predetermined obstacle is lower than the predetermined value in accordance with the traveling environment.
<12> The information processing apparatus according to any one of <1> to <10>, in which
the recognition action control unit
performs control to switch the recognition algorithm of the recognition unit to a recognition algorithm in which a frequency of processing of recognizing a predetermined obstacle is higher than a predetermined frequency in a case where an existence probability of the predetermined obstacle is higher than a predetermined value in accordance with the traveling environment, and
performs control to switch the recognition algorithm of the recognition unit to a recognition algorithm in which the frequency of processing of recognizing the predetermined obstacle is lower than the predetermined frequency in a case where the existence probability of the predetermined obstacle is lower than the predetermined value in accordance with the traveling environment.
<13> The information processing apparatus according to any one of <1> to <12>, in which
the action planning algorithm includes a dynamic window approach (DWA) method, a reinforcement learning method, and a local trajectory planner (LTP) method as algorithms for planning the travel route according to the traveling environment.
<14> The information processing apparatus according to <13>, in which
the recognition action control unit switches the action planning algorithm of the action planning unit to the DWA method when it is necessary to reduce a load on the action planning unit in accordance with the traveling environment.
<15> The information processing apparatus according to <13>, in which
the recognition action control unit switches the action planning algorithm of the action planning unit to the reinforcement learning method when it is necessary to smooth a motion of the mobile apparatus along the travel route or it is necessary to avoid an unknown obstacle in accordance with the traveling environment.
<16> The information processing apparatus according to <13>, in which
the recognition action control unit switches the action planning algorithm of the action planning unit to the LTP method when it is necessary to plan a travel route that enables avoidance of the obstacle with higher accuracy than predetermined accuracy in accordance with the traveling environment.
<17> The information processing apparatus according to any one of <1> to <16>, in which
the recognition action control unit switches the action planning algorithm of the action planning unit and switches a parameter used in processing by the action planning algorithm in accordance with the traveling environment.
<18> An information processing method including steps of:
recognizing an obstacle on the basis of sensor information by a recognition algorithm for recognizing the obstacle;
planning a travel route of a mobile apparatus by an action planning algorithm for planning the travel route; and
performing control to switch at least any of the recognition algorithm and the action planning algorithm on the basis of a traveling environment of the mobile apparatus.
<19> A program for causing a computer to function as:
a recognition unit that has a recognition algorithm for recognizing an obstacle and recognizes the obstacle by the recognition algorithm on the basis of sensor information;
an action planning unit that has an action planning algorithm for planning a travel route, and plans the travel route of a mobile apparatus by the action planning algorithm; and
a recognition action control unit that performs control to switch at least any of the recognition algorithm and the action planning algorithm on the basis of a traveling environment of the mobile apparatus.

### REFERENCE SIGNS LIST

1 Automated driving control system
2, 2-1 to 2-n Vehicle
3 Recognition action management server
4 Network
11 Vehicle system
21 Vehicle control electronic control unit (ECU)
22 Communication unit
23 Map information accumulation unit
24 Position information acquisition unit
25 External recognition sensor
26 In-vehicle sensor
27 Vehicle sensor
28 Storage unit
29 Travel assistance/automated driving control unit
30 Driver monitoring system (DMS)
31 Human machine interface (HMI)
32 Vehicle control unit
41 Communication network
51 Camera
52 Radar
53 LiDAR
54 Ultrasonic sensor
61 Analysis unit
62 Action planning unit
62a, 62a-1 to 62a-n, 61a-1 to 62a-x algorithm
Action planning
63 Operation control unit
64 Recognition action control unit
71 Self-position estimation unit
72 Sensor fusion unit
73 Recognition unit
73a, 73a-1 to 73a-m, 73a-1 to 73a-y Recognition algorithm

1. An information processing apparatus comprising:
a recognition unit that has a recognition algorithm for recognizing an obstacle and recognizes the obstacle by the recognition algorithm on a basis of sensor information;
an action planning unit that has an action planning algorithm for planning a travel route, and plans the travel route of a mobile apparatus by the action planning algorithm; and
a recognition action control unit that performs control to switch at least any of the recognition algorithm and the action planning algorithm on a basis of a traveling environment of the mobile apparatus.

2. The information processing apparatus according to claim 1, further comprising
a storage unit that stores at least any of a plurality of the recognition algorithms according to the traveling environment and a plurality of the action planning algorithms according to the traveling environment, wherein
the recognition action control unit searches the storage unit for at least any of the recognition algorithm and the action planning algorithm corresponding to the traveling environment, and performs control to switch at least any of the recognition algorithm of the recognition unit and the action planning algorithm of the action planning unit to the searched recognition algorithm and the searched action planning algorithm.

3. The information processing apparatus according to claim 1, further comprising
a position information acquisition unit that acquires current position information of the information processing apparatus, wherein
the recognition action control unit specifies the traveling environment on a basis of the position information, and performs control to switch at least any of the recognition algorithm and the action planning algorithm on a basis of the specified traveling environment.

4. The information processing apparatus according to claim 3, further comprising
a map information accumulation unit that accumulates map information in which a traveling environment is recorded for each position information, wherein
the recognition action control unit specifies the traveling environment corresponding to the position information on a basis of the map information accumulated in the map information accumulation unit.

5. The information processing apparatus according to claim 4, wherein
the recognition action control unit performs control, on a basis of the map information accumulated in the map information accumulation unit, to switch at least any of the recognition algorithm of the recognition unit and the action planning algorithm of the action planning unit to the recognition algorithm and the action planning algorithm that correspond to a new traveling environment at a position where the traveling environment corresponding to the position information changes.

6. The information processing apparatus according to claim 5, wherein
the recognition action control unit performs control, on a basis of the map information accumulated in the map information accumulation unit, to stop the mobile apparatus and switch at least any of the recognition algorithm of the recognition unit and the action planning algorithm of the action planning unit to the recognition algorithm and the action planning algorithm that correspond to the new traveling environment at the position where the traveling environment corresponding to the position information changes.

7. The information processing apparatus according to claim 5, wherein
a switching zone is set at a position a predetermined distance before the position where the traveling environment changes, and
the recognition action control unit controls to switch at least any of the recognition algorithm of the recognition unit and the action planning algorithm of the action planning unit to the recognition algorithm and the action planning algorithm that correspond to the new traveling environment while moving the mobile apparatus when the mobile apparatus is within the switching zone.

8. The information processing apparatus according to claim 7, wherein
the recognition action control unit controls to switch at least any of the recognition algorithm of the recognition unit and the action planning algorithm of the action planning unit to the recognition algorithm and the action planning algorithm that correspond to the new traveling environment while moving the mobile apparatus by causing an external server to substitute for a function of at least any of the recognition unit and the action planning unit when the mobile apparatus is in the switching zone.

9. The information processing apparatus according to claim 8, wherein
the external server is a cloud computer that is capable of substituting for functions of the recognition unit and the action planning unit.

10. The information processing apparatus according to claim 1, wherein
the recognition action control unit specifies the traveling environment on a basis of date and time or weather, and performs control to switch at least any of the recognition algorithm and the action planning algorithm on a basis of the specified traveling environment.

11. The information processing apparatus according to claim 1, wherein
the recognition action control unit
performs control to switch the recognition algorithm of the recognition unit to a recognition algorithm for turning on processing of recognizing a predetermined obstacle in a case where an existence probability of the predetermined obstacle is higher than a predetermined value in accordance with the traveling environment, and
performs control to switch the recognition algorithm of the recognition unit to a recognition algorithm for turning off the processing of recognizing the predetermined obstacle in a case where the existence probability of the predetermined obstacle is lower than the predetermined value in accordance with the traveling environment.

12. The information processing apparatus according to claim 1, wherein
the recognition action control unit
performs control to switch the recognition algorithm of the recognition unit to a recognition algorithm in which a frequency of processing of recognizing a predetermined obstacle is higher than a predetermined frequency in a case where an existence probability of the predetermined obstacle is higher than a predetermined value in accordance with the traveling environment, and
performs control to switch the recognition algorithm of the recognition unit to a recognition algorithm in which the frequency of processing of recognizing the predetermined obstacle is lower than the predetermined frequency in a case where the existence probability of the predetermined obstacle is lower than the predetermined value in accordance with the traveling environment.

13. The information processing apparatus according to claim 1, wherein
the action planning algorithm includes a dynamic window approach (DWA) method, a reinforcement learning method, and a local trajectory planner (LTP) method as algorithms for planning the travel route according to the traveling environment.

14. The information processing apparatus according to claim 13, wherein
the recognition action control unit switches the action planning algorithm of the action planning unit to the DWA method when it is necessary to reduce a load on the action planning unit in accordance with the traveling environment.

15. The information processing apparatus according to claim 13, wherein
the recognition action control unit switches the action planning algorithm of the action planning unit to the reinforcement learning method when it is necessary to smooth a motion of the mobile apparatus along the travel route or it is necessary to avoid an unknown obstacle in accordance with the traveling environment.

16. The information processing apparatus according to claim 13, wherein
the recognition action control unit switches the action planning algorithm of the action planning unit to the LTP method when it is necessary to plan a travel route that enables avoidance of the obstacle with higher accuracy than predetermined accuracy in accordance with the traveling environment.

17. The information processing apparatus according to claim 1, wherein
the recognition action control unit switches the action planning algorithm of the action planning unit and switches a parameter used in processing by the action planning algorithm in accordance with the traveling environment.

18. An information processing method comprising steps of:
recognizing an obstacle on a basis of sensor information by a recognition algorithm for recognizing the obstacle;
planning a travel route of a mobile apparatus by an action planning algorithm for planning the travel route; and
performing control to switch at least any of the recognition algorithm and the action planning algorithm on a basis of a traveling environment of the mobile apparatus.

19. A program for causing a computer to function as:
a recognition unit that has a recognition algorithm for recognizing an obstacle and recognizes the obstacle by the recognition algorithm on a basis of sensor information;
an action planning unit that has an action planning algorithm for planning a travel route, and plans the travel route of a mobile apparatus by the action planning algorithm; and
a recognition action control unit that performs control to switch at least any of the recognition algorithm and the action planning algorithm on a basis of a traveling environment of the mobile apparatus.
